(19) United States
(12) Patent Application Publication
(10) Pub. No.: US 2023/0377423 A1
(43) Pub. Date: Nov. 23, 2023

(54) SYSTEMS AND METHODS FOR MANAGING LIVE EVENT MARKETS

(71) Applicant: Bid Ventures, Inc., Boston, MA (US)

(72) Inventors: John Tyler CARLIN, Boston, MA (US); Josh DICKSON, Boston, MA (US)

(21) Appl. No.: 18/318,485

(22) Filed: May 16, 2023

Related U.S. Application Data
(60) Provisional application No. 63/344,388, filed on May 20, 2022.

(51) Int. Cl. G07F 17/32

(52) U.S. Cl. CPC G07F 17/3288; G07F 17/3276; G07F 17/3244

(57) ABSTRACT

Aspects of the present disclosure include methods, systems, and non-transitory computer readable media for generating a live event market including a plurality of players of an event determining share payout amounts corresponding to a number of the plurality of players in the live event market, receiving at least a first offer to short sell one or more first shares associated with a first player and a second offer to short sell one or more second hares associated with a second player, determining a higher number of shares between a first number of the one or more first shares and a second number of the one or more second shares, assigning a highest reserve price, based on the share payout amounts, to a player associated with the higher number of shares, and receiving an amount of proceeds based on the highest reserve price and the higher number of shares.

### CROSS-REFERENCE TO RELATED APPLICATION

This application claims the benefit of U.S. Provisional Application No. 63/344,388, entitled “SYSTEMS AND METHODS FOR MANAGING LIVE EVENT MARKETS” filed on May 20, 2022, the contents of which are expressly incorporated by reference herein in their entireties.

### TECHNICAL FIELD

The present disclosure relates to systems and methods for managing live event markets.

### BACKGROUND

Traditional fantasy games for sporting, real-world, scored, or ranked events, among others, continue to be popular for users. These games allow a user to select one or more players of an event (e.g., a football game) before the event starts, and based on how well the one or more players perform during the event, potentially win cash or other prizes based on the one or more players' performances. While service providers of traditional fantasy games may allow trading of players throughout a season, this feature is typically reserved for season-long game formats. For many of the daily fantasy or skill-based options, once an event begins, a user retains the player until the event ends and therefore is unable to manage the player, such as trading the player, during the event.

Accordingly, there is a need in the art for service providers of skill-based or daily fantasy games to provide further methods for playing games and managing players during sporting and/or other events.

### SUMMARY

The following presents a summary of one or more aspects of the disclosure in order to provide a basic understanding of such aspects. This summary is not an extensive overview of all contemplated aspects, and is intended to neither identify key or critical elements of all aspects, nor delineate the scope of any or all aspects. Its sole purpose is to present some concepts of one or more aspects of the disclosure in a simplified form as a prelude to the more detailed description that is presented later.

Aspects of the present disclosure include methods, systems, and non-transitory computer readable media for generating a live event market including a plurality of players of an event determining share payout amounts corresponding to a number of the plurality of players in the live event market, receiving at least a first offer to short sell one or more first shares associated with a first player and a second offer to short sell one or more second hares associated with a second player, determining a higher number of shares between a first number of the one or more first shares and a second number of the one or more second shares, assigning a highest reserve price, based on the share payout amounts, to a player associated with the higher number of shares, and receiving an amount of proceeds based on the highest reserve price and the higher number of shares.

Aspects of the present disclosure include methods, systems, and non-transitory computer readable media for generating a live event market including a plurality of players of an event, determining share payout amounts corresponding to a number of the plurality of players in the live event market, receiving an offer to short sell one or more first shares associated with a first player, identifying a minimum margin value of one or more second shares associated with a second player, and allocating at least a portion of the minimum margin value to short proceeds of the one or more shares associated with the player.

To the accomplishment of the foregoing and related ends, the one or more aspects of the disclosure comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative implementations when read in conjunction with the accompanying drawings, wherein:

FIG. 1 illustrates a conceptual view of an example system for managing live event markets, according to aspects of the disclosure;

FIG. 2 illustrates a conceptual view of an example market server of FIG. 1, according to aspects of the disclosure;

FIGS. 3A-3J illustrate conceptual views of an example live event market through a user terminal of the system of FIG. 1, according to aspects of the disclosure;

FIG. 4 illustrates an example bidding process performed by the system of FIG. 1, according to aspects of the disclosure;

FIGS. 5A-5H illustrate additional conceptual views of an example live event market through a user terminal of the system of FIG. 1, according to aspects of the disclosure;

FIG. 6 illustrates an example of shorting according to aspects of the present disclosure;

FIG. 7 illustrates an example of the margin feature according to aspects of the present disclosure;

FIG. 8 illustrates an example of a flowchart for implementing shorting in a live event market according to aspects of the present disclosure;

FIG. 9 illustrates an example of a flowchart for implementing margin in a live event market according to aspects of the present disclosure;

FIG. 10 illustrates a system diagram of an example of various hardware components and other features for managing live event markets, according to aspects of the disclosure; and

FIGS. 11A-C illustrate additional conceptual views of an example live event market via a user terminal of the system of FIG. 1, according to aspects of the disclosure.

### DETAILED DESCRIPTION

The present disclosure provides systems and methods for managing live event markets via one or more computing devices. In an example, techniques disclosed herein provide systems and methods for organizing a live event market for a plurality of users that allow each of the plurality of users to buy and sell shares of individual players of an event (e.g., a sporting event) before and during the event, and to manage the live event market such that ranking of the plurality of users based on the shares may be performed after the event ends.

Turning now to the figures, examples of systems and methods are depicted. It is to be understood that aspects of the figures may not be drawn to scale and are instead drawn for illustrative purposes.

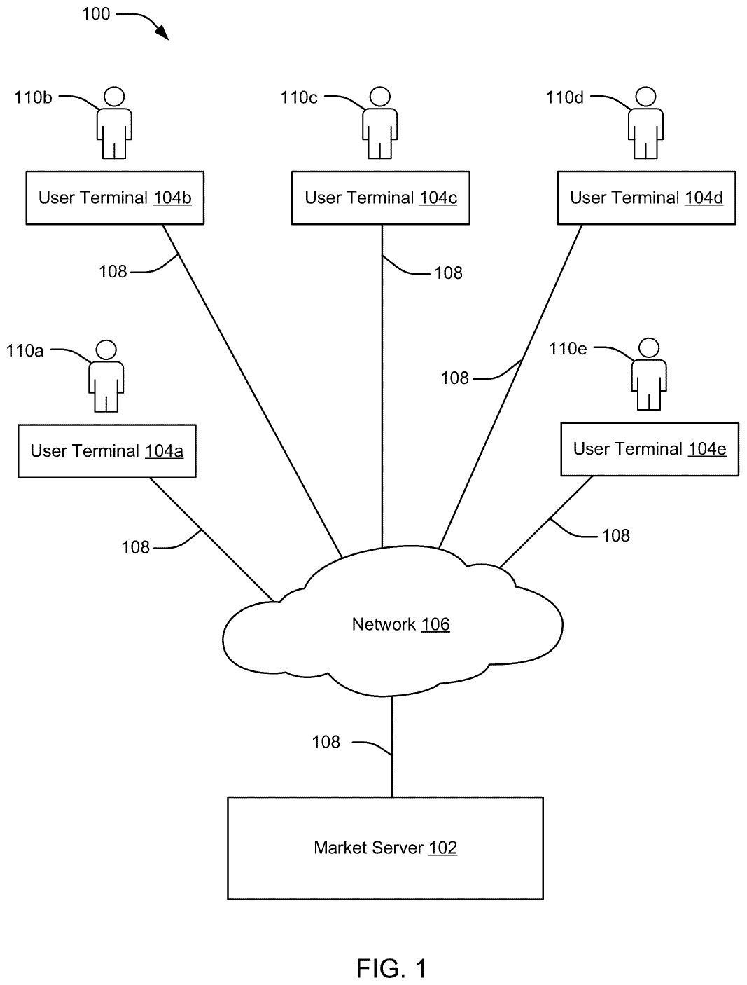

Referring to FIG. 1, a conceptual view of various features of an example system 100 for managing a live event market is depicted. In the example, the live event may include any sporting event or competition (e.g., football, basketball, baseball, soccer). In an aspect, the system 100 may include a market server 102 configured to organize and manage the live event market. The market server 102 may allow users 110a-110e to perform various actions, such as placing bids on shares of players, purchasing or selling the shares, trading the shares, and/or performing any other actions related to the live event market via user terminals 104a-104e. In one variation, the market server 102 may be one or more of a PC, minicomputer, mainframe computer, microcomputer, or other device having a processor and a repository for data and/or connection to a repository for data.

The user terminals 104a-104e may be configured to provide a browser, an application, or other software associated with the live event market for interaction by the users 110a-110e with the live event market. The user terminals 104a-104e may include one or more personal computers (PCs), minicomputers, mainframe computers, microcomputers, telephonic devices, or wireless devices, such as personal digital assistants (“PDAs”) or hand-held wireless devices.

The market server 102 may be communicatively coupled with the user terminals 104a-104e via a network 106, such as the Internet or an intranet, and couplings 108. The couplings 108 may include any one or more wired, wireless, and/or fiberoptic links. In another example, the method and system in accordance with aspects described herein operate in a stand-alone environment, such as on a single user terminal.

While FIG. 1 illustrates five user terminals 104a-104e, implementations of the system 100 are not limited to this number of user terminals. Instead, two or more user terminals may be used in other implementations to participate in a live event market along with two or more couplings 108.

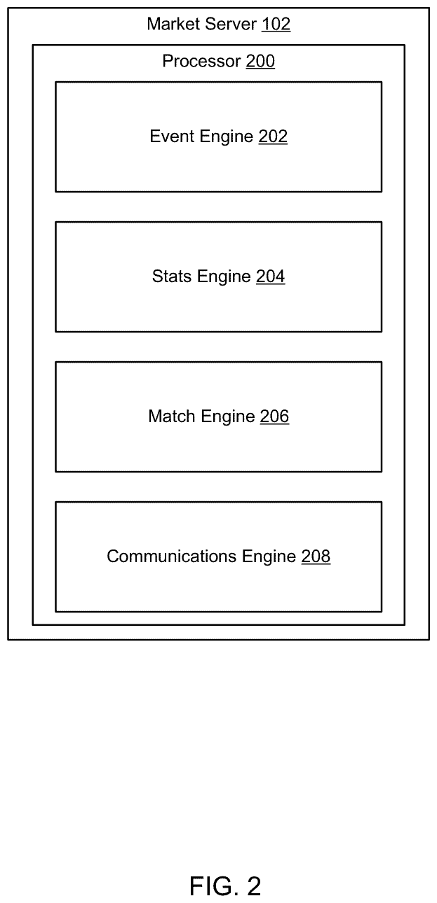

Referring to FIG. 2, various features of an example market server 102 are shown. The market server 102 may include one or more processors 200 configured to run one or more engines for managing live event markets. In an example, one or more of the one or more processors 200 may include an event engine 202 configured to run all live event markets. The event engine 202 may generate new events, specify contests or markets, include games, tournaments, or specific events (e.g., PGA Masters), determine event stock field (e.g., top 50 players), set or increase a number of available shares per player (e.g., 100 shares for each player), set final share valuations (e.g., #1: f$50, #2: f$45 . . . , #50: f$1, where f$ may indicate a fantasy dollar or point), switch event states (e.g., initial player offering (IPO) to LIVE to FINAL), and/or pay out users, among other functions.

The one or more processors 200 may also include a statistics engine (interchangeably referred to herein as a “stats engine”) 204 configured to collect live data from third-party data providers and score events. The stats engine 204 may connect to the third-party data providers, tracking stats for players and games in every event, and/or calculate fantasy points scored based on stats from the third-party data providers and one or more scoring rules.

One or more of the one or more processors 200 may also include a match engine 206 configured to process bids, offers, and trades related to shares for the players of the live event. The match engine 206 may issue player shares to the appropriate user 110 (FIG. 1), receive new orders for shares, process cancel requests, and/or match share trades based on price and event stock.

One or more of the one or more processors 200 may also include a communications engine 208 configured to communicate to the users 110 (FIG. 1) via, for example, alerts and messages. The communications engine 208 may alert relevant users to events starting or ending, issue outbid alerts during an IPO phase, notify users of completed trades, and/or send new trade offers, big price movements, etc. to relevant users.

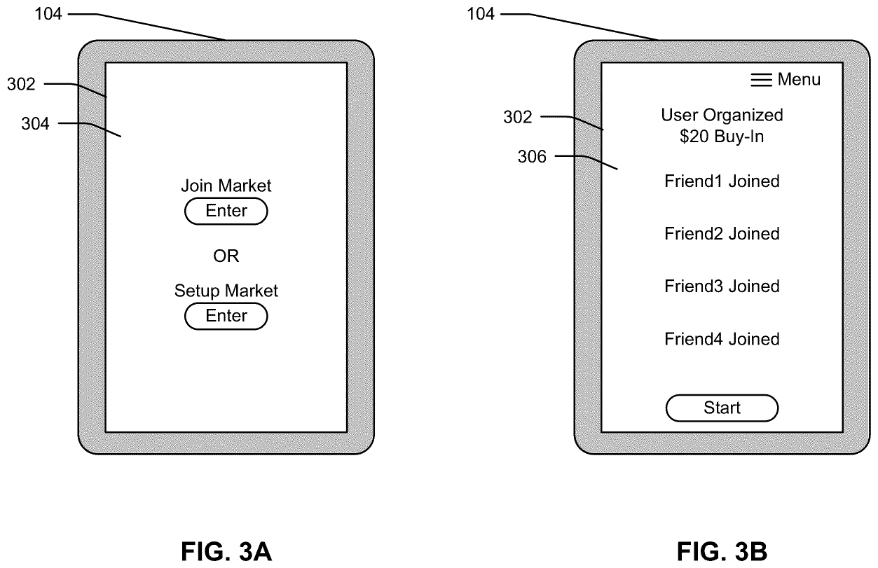

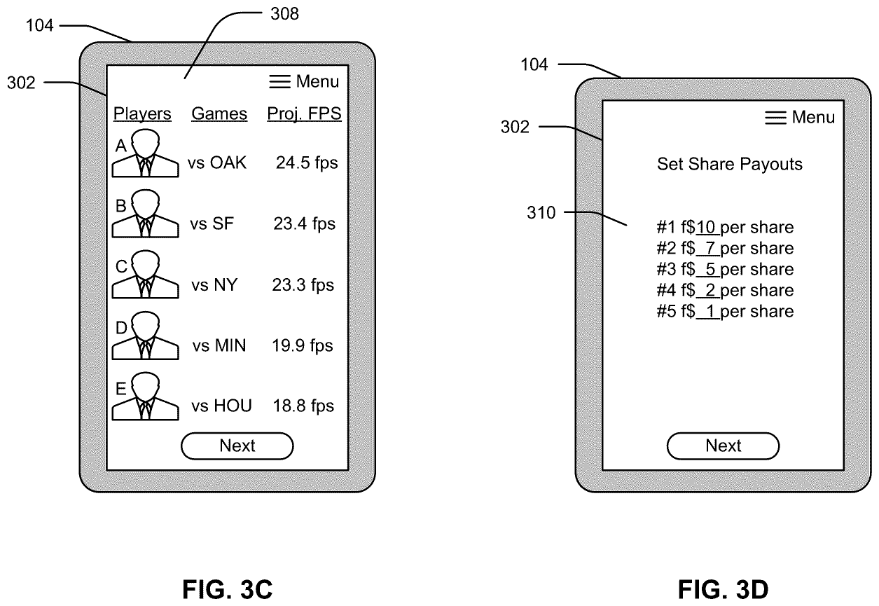

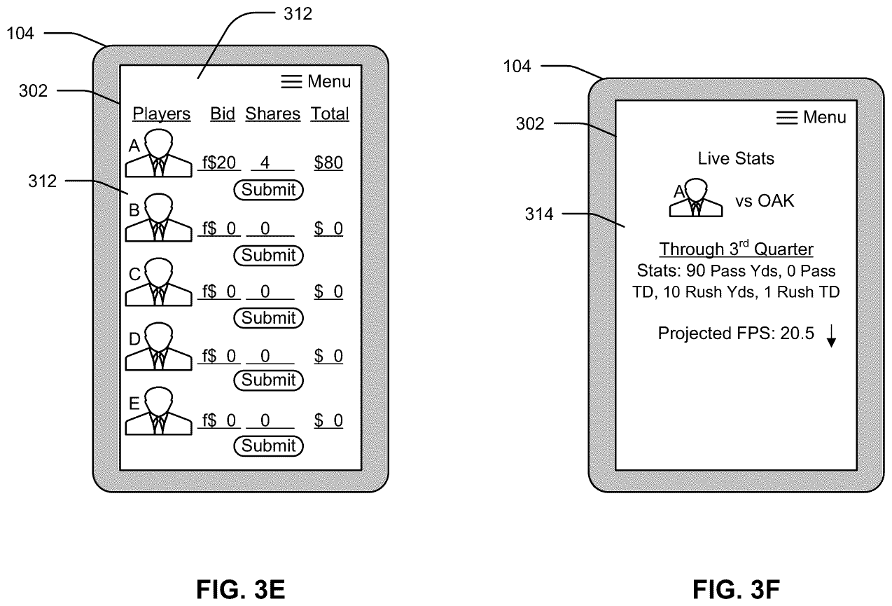

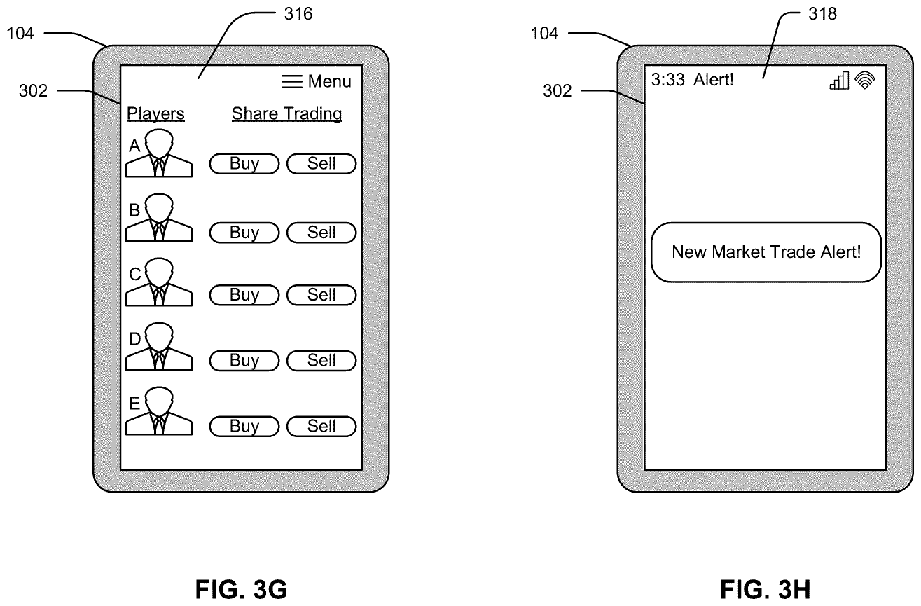

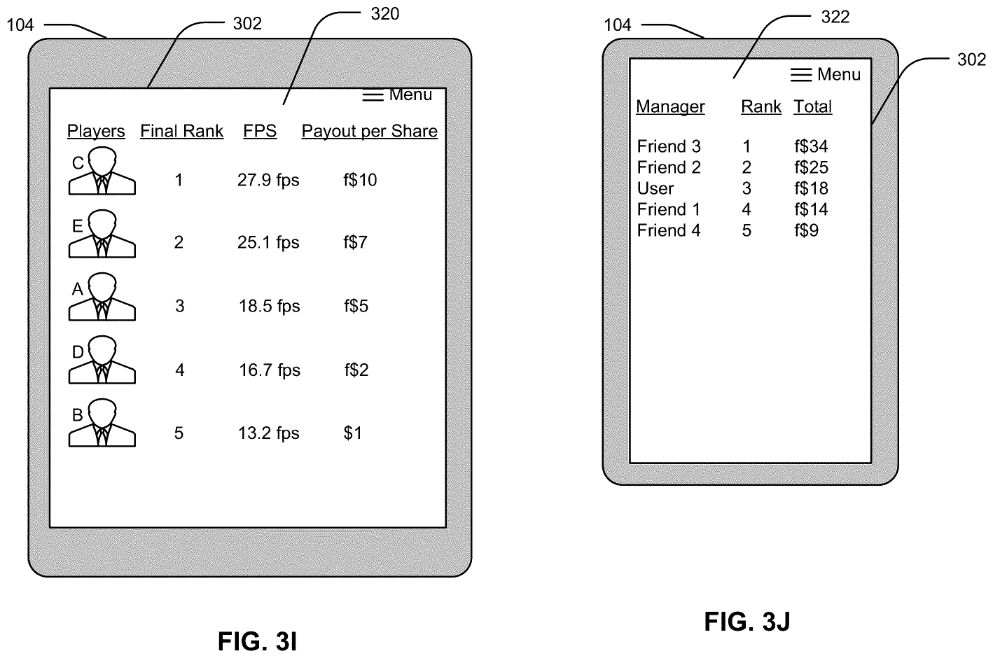

Further implementations of the system 100 are described below in reference to FIGS. 3A-3J, which illustrate an example of operation of the live event market through views by a single user terminal 104, which may represent any one of the user terminals 104a-104e.

Referring to FIG. 3A, a user terminal 104 (FIG. 1) may access the market server 102 (FIG. 1) via a browser, an application, or other software associated with the market server 102 (FIG. 1) and/or features to communicate with the market server 102 (FIG. 1). Content from the market server 102 (FIG. 1) may be displayed on a display 302 of the user terminal 104 (FIG. 1) for the user 110 (FIG. 1) to view.

As illustrated by FIG. 3A, the market server 102 (FIG. 1) may initially provide the user terminal 104 (FIG. 1) (or if an application on the user terminal 104 (FIG. 1), the user terminal 104 (FIG. 1) may provide) an authentication page 304 asking the user 110 (FIG. 1) to join a market or setup a new market. In an example, the sign-in page 304 may also include information, content, and/or one or more pages to allow the user 110 (FIG. 1) to enter identification information (e.g., username, password) and/or to register to the market server 102 (FIG. 1). When joining a market, the market server 102 (FIG. 1) may provide information to the user terminal 104 (FIG. 1), including, for example, available markets and events, number of participants, buy-in amount, or other information for the user 110 (FIG. 1) to determine which market to join. When setting up a market, the market server 102 (FIG. 1) may provide information for the user terminal 104 (FIG. 1) to start a new market and/or a private market. Accordingly, the market server 102 (FIG. 1) may provide similar information as joining a market but may also include information for the user 110 (FIG. 1), such as to select a market, select players for the market, a buy-in amount, payout values per share for the market, and/or to invite one or more friends to join the market. Further, the market server 102 (FIG. 1) and the user terminal 104 (FIG. 1) may provide a buy-in page 306 (FIG. 3B) including information of each of the users 110 (FIG. 1) and the buy-in amount (e.g., $20 buy-in per user).

One of ordinary skill in the art will recognize that any number of friends may join, and the buy-in amount may be $0 or any amount selected by the user or specified by the server 110 (FIG. 1) (and/or according to rules/regulations of the market server 102 (FIG. 1) or state regulations). However, for illustrative purposes, in this implementation being described, at least four users (friend1-friend4) have joined, and the buy-in amount has been set at $20 per user 110 (FIG. 1) (5 users×$20 buy-in =$100 in the prize pool). The users 110 (FIG. 1) may receive market money (e.g., fantasy dollars (indicated as f$) or points) that correspond to the amount in the prize pool, where the market money may be spent in the market. In the example provided below, the market money may have a 1 to 1 value with the amount in the prize pool, such that the users 110 (FIG. 1) each receive f$100 to spend in the market. However, other ratios of market money to prize pool amounts may be used.

As disclosed herein, as shown in FIG. 1, the market server 102 may provide information to the user terminal 104 for the user to select one or more events and event players from the one or more events for customizing the market. For example, the user 110 may select football games as the events and then select five quarterbacks for the market (although any number of players may be selected for the market), as illustrated by the player page 308 of FIG. 3C. In one example, each of the users 110 (FIG. 1) may receive information on the players (e.g., players A-E) in the event, including, for example, the games the players are participating in and projected fantasy points (“FPS” or “fps”) that each of the players will have during respective games, as illustrated by FIG. 3C.

Further, the market server 102 (FIG. 1) may provide information to the user terminal 104 (FIG. 1) for the user 110 (FIG. 1) to set share payout values, as illustrated by the share payout page 310 of FIG. 3D. In an example, share payouts may be awarded based on the most fantasy points scored. The share payouts may indicate an amount of market money for each of the number of shares for each event player of the market based on a rank of the event players at the end of the market (e.g., end of all events in the market).

In the example of FIG. 3D, the sum of the share values (e.g., f$10+f$7+f$5+f$2+f$1) equals f$25, which indicates that f$25 is needed to create 1 share for each event player available. This indication also reflects that, since there is f$100 in the prize pool, each player has up to 4 shares (f$100 prize pool/f$25 per share for all players) available to be acquired. Based on the initial setup information, the market server 102 (FIG. 1) therefore generates 4 shares as available for each of the players A-E.

Once the initial information is obtained, the market server 102 (FIG. 1) may generate and/or initiate a market (in this example, a private market for the user and friend1-friend4) according to the buy-in amount, the selected events, and the selected event players, among other possible selections.

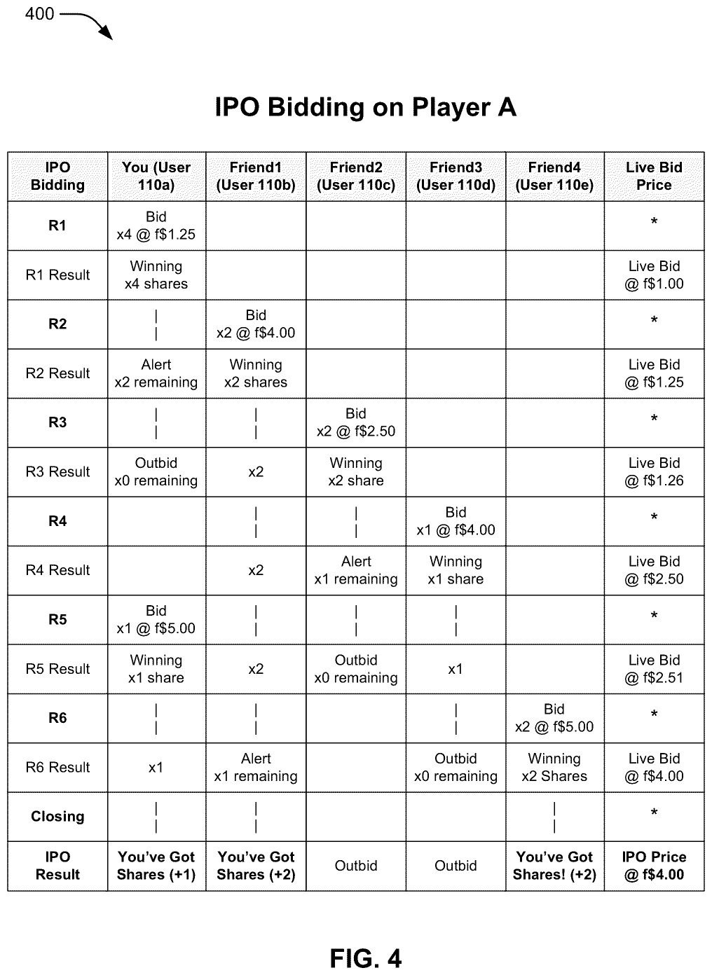

The market server 102 (FIG. 1) may provide information to the user terminal 104 (FIG. 1) to initiate an IPO for bidding on shares of one or more event players (e.g., players A-E) of the market, as shown by IPO page 312 of FIG. 3E. In an example, the market server 102 (FIG. 1) may allow bidding to be performed for one event player at a time, such that bidding happens sequentially. In another example, IPO bidding may be dynamic and happen in parallel (e.g., multiple users 110 (FIG. 1) may submit bids for the same event player or different players, at the same time or different times, at any point up until the bidding ends). A graphical illustration of an example IPO bidding process 400 for bidding on shares for player A is illustrated in FIG. 4. As illustrated, the bidding process 400 may include one or more rounds (R1-R6) of bidding and may result in multiple users 110 (FIG. 1) purchasing shares in a single event player.

In an example, the IPO bidding process may be displayed on the display 302 (FIGS. 3A-3J) for the user 110 (FIG. 1) to view live bidding for each of the players. The user 110 (FIG. 1) may have the ability to bid at a higher bid amount (e.g., f$1.25 by user 110a in FIG. 4) than the live bid amount (e.g., f$1.00 for the initial live bid price), to act as a reserve price. In an example, the market server 102 (FIG. 1) may provide notifications (e.g., Bid, Alert, Outbid, Winning, You've Got Shares (+1)) via the user terminals 104 (FIG. 1). The notifications may be in real-time and may allow users 110 (FIG. 1) to manage bid amounts including increase bid amounts (e.g., to f$5.00 by user 110a in FIG. 4) any time before the IPO closes. In an example, the IPO bidding process may continue until a first game or event is about to start. When the IPO closes, all users 110 (FIG. 1) with a winning bid may pay the same amount (e.g., f$4.00 in FIG. 4) for shares of a player. For example, all winning bidders may obtain shares at a designated amount (e.g., 1 cent) more than a highest bidding user 110 (FIG. 1) who bid for one or more shares, but did not bid high enough to win any shares because the losing bid of the user 110 (FIG. 1) was less than everyone else's who won (see example with regard to Table 2 below). The amount of market money paid per share during the IPO bidding process may be called the IPO price.

As an example, referring to FIG. 4, the match engine 206 (FIG. 2) may provide a list of players to the user terminals 104 (FIG. 1) for the users 110 (FIG. 1) to bid on during an IPO, a number of shares per player, and an initial share price for each of the shares, as described herein. In this example, the match engine 206 (FIG. 2) may indicate the initial bid price of f$1.00 per share for player A.

As illustrated by FIG. 4, the match engine 206 (FIG. 2) may display a bidding process in rounds (e.g., R1-R6), which correlate to when a new bid is being placed. However, in other examples, the match engine 206 (FIG. 2) may display the bidding process differently. While this example illustrates bid information for each of the users 110 (FIG. 1) being displayed to all of the users 110 (FIG. 1), in other examples, the user 110 (FIG. 1) may only view notifications and information corresponding to the user's own respective bids. For example, the users 110b-110e may not view the bid information for the user 110a, and user 110a may not view the bid information for the users 110b-110e.

In this example, in a first round R1, the match engine 206 (FIG. 2) may receive a bid amount of f$1.25 from the user 110a to purchase 4 shares of player A. The user 110a has a reserve price of f$0.25 over the initial bid price amount of f$1.00. The match engine 206 (FIG. 2) may 110a is currently winning 4 shares of player A. The match engine 206 (FIG. 2) may store the bid information (e.g., bid amount of f$1.25; current winning shares) of 110a in, for example, a database in a memory.

In a second round R2, the match engine 206 (FIG. 2) may receive a bid of f$4.00 from the user 110b to purchase 2 shares of player A. Due to the higher bid amount, the match engine 206 (FIG. 2) may increase the live bid price from the initial live bid price of f$1.00 to f$1.25 per share, as this corresponds to the highest amount that user 110a was willing to pay. Based on the bid the results of the second round R2. Further, the match engine 206 (FIG. 2) may store bid information of the users 110a-110b in memory.

In a third round R3, the match engine 206 (FIG. 2) may receive a bid of f$2.50 from the user 110c to purchase 2 shares of player A. Due to this bid amount, the match engine 206 (FIG. 2) may increase the live bid price from the current live bid price of f$1.25 to f$1.26 per share, as this corresponds to 1 cent over the losing bidder's (e.g., user 110a) bid amount. Based on the bid amount by the user 110c, the match engine 206 (FIG. 2) may determine that the user 110a is not winning any shares of player A and that the users 110b-110c are each winning 2 shares of player A. The match engine 206 (FIG. 2) may individually notify the users 110a-110c of the results of the third round R3. Further, the match engine 206 (FIG. 2) may store bid information of the users 110a-110c in memory.

Similar operations may be performed by the match engine 206 (FIG. 2) for each of the remaining rounds (e.g., R4-R6) which may allow more users 110 (FIG. 1) to join in the bidding process for shares of player A and for users 110 (FIG. 1) to increase their bid amounts during the bidding process. The bidding process may continue until a predetermined time (e.g., the time at which the event that player A is participating in begins or is about to start). At this point, the match engine 206 (FIG. 2) may close the IPO for player A and determine the IPO price and the winners of each of the shares. The match engine 206 (FIG. 2) may notify each of the users 110a-110e that participated in the IPO of the results of the IPO (or provide bid information corresponding to respective users), and bid information for the IPO may be stored in memory.

In an example, the market server 102 (FIG. 1) may receive bids for shares from the users 110 (FIG. 1), sort the bids, and award shares based on descending bid amount and timestamp. In an example, if the market server 102 (FIG. 1) receives more than one bid at the same amount from different users 110 (FIG. 1), the market server 102 (FIG. 1) selects the user 110 (FIG. 1) who first submitted a bid as a winner.

As an example of play, assume there are 4 shares available for each player, and bids follow Tables 1 and 2 below. In this example, the IPO price may be either: the minimum price needed to sell more than the available shares, or a designated amount (e.g., one cent) more than the lowest bidder who wanted shares, but didn't bid enough to qualify for the top 4.

In an example, for multiple bidders at f$3.50, the tiebreaker may be a timestamp for the first two, as received by the market server 102 in FIG. 1. All bidders in the example of Table 1 pay f$3.50 per share (including those who bid at f$5.00 per share).

TABLE 1

| Descending Bid | Shares Requested | Cumulative Shares | Live |
|---|---|---|---|
| Amount | By Bid Amount | by Descending Bid | Bid Price |
| f$5.00 | x2 | 2 | |
| f$3.50 | x4 | 6 | <<Price = f$3.50 |
| f$2.00 | x4 | 10 | |

In another example, all users above f$2.00 may receive shares at f$2.01, +f$0.01 more than the lowest bidder as shown by Table 2.

TABLE 2

| Descending | Shares Requested | Cumulative Shares | Live |
|---|---|---|---|
| Bid Amount | by Bid Amount | by Descending Bid | Bid Price |
| f$5.00 | x1 | 1 | |
| f$3.50 | x3 | 4 | |
| f$2.00 | x4 | 8 | <<Price = f$2.01 |

Once the IPO closes and once one or more events or games begin, the market server 102 (FIG. 1) or the stats engine 204 (FIG. 2) may provide event statistics information to the user terminal 104 (FIG. 1), e.g., via the stat page 314 of FIG. 3F. The event statistics information may include, for example, information on one or more players of the market (e.g., players A-E), one or more games/events of the market, value of a user's shares based on player or game statistics, change in projected fantasy points, etc.

Further, once the IPO is closed, the market server 102 (FIG. 1) may provide users 110 (FIG. 1) with access to information regarding their shares, and trading may go live. During the live market (e.g., while games/events of the market are being played), the market server 102 (FIG. 1) and/or match engine 206 (FIG. 2) may provide information to the user terminal 104 (FIG. 1) for the user 110 (FIG. 1) to access share trading, as illustrated by the trading page 316 of FIG. 3G. In an example, each share may be worth whatever a lowest accepted bid is that is received by the user 110 (FIG. 1).

In an example, the market server 102 (FIG. 1) and/or the match engine 206 (FIG. 2) via the communications engine 208 (FIG. 2) may send out a message 318, as illustrated by FIG. 3H, to one or more of the users 110 (FIG. 1) via the user terminals 104 (FIG. 1), the message 318 indicating one or more of trade offers, price changes, and other alerts for buying, selling, or trading shares. In an example, the market server 102 (FIG. 1) and/or the match engine 206 (FIG. 2) may determine relevant users 110 (FIG. 1) to receive the message 318 based one or more of user preferences, holding information, watch list selections, player/game statistics information, etc. The messages 318 may be received by the user terminals 104 (FIG. 1) on any or all available platforms supported, including mobile, web, email, etc. These messages 318 may be configurable, actionable, and generated/updated in real-time. Content of the messages 318 may be customized to show information specific to each user 110 (FIG. 1). Further, messages 318 may include links to display buy/sell shares related to the content.

Through in-app settings at the user terminals 104 (FIG. 1), the users 110 (FIG. 1) may control which types of messages they prefer to receive, and set thresholds to control frequency of notification. Further, the settings may allow alerts to be snoozed for a period of time, or duration of a game or event. Message preferences may be set at an account-level or event-level. The market server 102 (FIG. 1) may determine when, and how often, to send messages. This determination may be made to promote some expected action or stimulate trading by the user 110 (FIG. 1).

While examples herein describe a single user terminal 104 (FIG. 1) per user 110, this disclosure is not limited to this example. Instead, the user 110 may access the market server 102, thereby access the market or receive messages from the market server 102 on a number of user terminals 104 (FIG. 1) (e.g., laptop and mobile device, among other terminals).

At the end of the market, for example, when all games corresponding to the market have ended, the market server 102 (FIG. 1) and/or the match engine 206 (FIG. 2) may determine a score for each of the event players (e.g., players A-E) in the market based on the data from the games, and rank the event players based on the score. The market server 102 (FIG. 1) and/or the match engine 206 (FIG. 2) via the communications engine 208 may send this information to the user terminal 104 (FIG. 1) for displaying on the display 302, as shown by the display 320 of FIG. 3I. Further, the market server 102 (FIG. 1) and/or the match engine 206 (FIG. 2) may determine a ranking of the users 110, as shown by the winners page 322 of FIG. 3J, based on payout per shares and a number of shares per player that each user 110 (FIG. 1) owns.

In an example, the market server 102 (FIG. 1) and/or the market engine 202 (FIG. 2) may provide a dynamic player option, such that an absolute number of players in a market are limited, without reducing the scope of tradeable players to less than that in an actual real-world game, or set of games.

For example, every eligible offensive player in any given National Football League (NFL) Sunday may be well over 300 players. Therefore, the market server 102 (FIG. 1) and/or the market engine 202 (FIG. 2) may be configured to limit the pool of players to, for example, the top 50 players by projected fantasy point totals. In doing so, the market server 102 (FIG. 1) and/or the market engine 202 (FIG. 2) may keep the player list more manageable and ensure there is demand for every player in the market. By limiting the pool to the top 50 players, some top performing players may be excluded in the market. Given the number of injuries in the NFL, a backup quarterback or a player who carries little to no user demand prior to kickoff may fill in for an injured starter, and go on to have a career day. That player would then be in high demand, and market server 102 (FIG. 1) and/or the market engine 202 (FIG. 2) may be configured to make that player tradeable without expanding the original list of players in the market. Therefore, a “Field” stock, for example, may be created as a catch-all for any player not listed, and it may be automatically assumed that the scoring player is the player in the Field stock with the highest fantasy point total. This information may be provided by the market server 102 (FIG. 1) and/or the match engine 206 (FIG. 2) to the user terminal 104 (FIG. 1) via the communications engine 208, such that the users 110 (FIG. 1) know while bidding on players. The market server 102 (FIG. 1) and/or the match engine 206 (FIG. 2) may update in real-time information to the user terminal 104 (FIG. 1) to reflect the stats of a current high scorer at that point in time. At an end of the market, the “Field” may pay out at whichever final valuation that player would have finished, had that player been listed in the original list of available players. In an example, an event may include multiple field designations (e.g. Gold Field, Silver Field, Bronze Field). These can be used to distinguish the top 3 unlisted point scorers, ordered accordingly.

In another aspect, the market server 102 (FIG. 1) and/or the match engine 206 (FIG. 2) may include a share ratchet process. For example, it may be assumed that, rather than setting the number of IPO shares to some static number, the overall share count is allowed to increase with bid prices—so as more money is added to the prize pool, in the form of new bids from users 110 (FIG. 1), more shares become available (uniformly across all players).

In a static market, the payout table for the market may be as shown by Table 3, thereby f$25 (f$10+f$7+f$5+f$2+f$1) is needed to guarantee 1 share for each player in a market at each payout.

TABLE 3

| Final Rank | Payout Per Share |
|---|---|
| #1 | f$10.00 |
| #2 | f$7.00 |
| #3 | f$5.00 |
| #4 | f$2.00 |
| #5 | f$1.00 |

However, the market server 102 (FIG. 1) and/or the match engine 206 (FIG. 2) may provide a set prize pool (e.g., at least $1,000) for a market and not rely on the original pool amount; therefore, the IPO auction may open with a set share amount (e.g., 40 shares—$1,000 prize pool/f$25 per single round of share payouts=40 shares available per event player) available for each of the 5 different event players.

In using the share ratchet process, as users 110 (FIG. 1) join the IPO, the market server 102 (FIG. 1) and/or the match engine 206 (FIG. 2) may increase live bid prices because there is more user demand than the initially available shares (e.g., 40). In an example, assuming all initially available 40 shares are claimed at each of the following bids:

TABLE 4

| Player Name | Live Bid Price | Requested Shares | Money From Bids |
|---|---|---|---|
| Player A | f$5.00 per share | x40 shares | =f$200 |
| Player B | f$4.00 per share | x40 shares | =f$160 |
| Player C | f$3.50 per share | x40 shares | =f$140 |
| Player D | f$3.00 per share | x40 shares | =f$120 |
| Player E | f$1.50 per share | x40 shares | =f$60 |

In this example, the market server 102 (FIG. 1) and/or the match engine 206 (FIG. 2) may add f$680 (f$200+f$160+f$140+f$120+f$60) in new user bids to the prize pool, with a 1-to-1 ratio of market money to prize pool, $1,680 total is in the prize pool ($1,000 platform guarantee+$680 in new user bids). Further, 67 shares ($1,680 total prize pool/f$25 per single round of share payouts) may be currently available due to the 27 newly minted shares (67 shares currently available−40 shares initially available) being added. As those 27 newly minted shares are claimed at each player's live bid price, the market server 102 (FIG. 1) and/or the match engine 206 (FIG. 2) may continuously add money from new user bids to the prize pool, which may in turn result in the ratchet increasing the available share count to accommodate the additional demand. In an example, the market server 102 (FIG. 1) and/or the match engine 206 (FIG. 2) may continue the bidding, and the resulting ratchet using this process, until the IPO ends. However, in an example, the market server 102 (FIG. 1) and/or the match engine 206 (FIG. 2) may have the share ratchet process disabled.

In another example, the market server 102 (FIG. 1) and/or the match engine 206 (FIG. 2) may reduce an initial guaranteed prize pool amount (e.g., $1000). For example, as money from new user bids flows in, the market server 102 (FIG. 1) and/or the match engine 206 (FIG. 2) may reduce some, or all, of the $1,000 prize pool initially guaranteed by the market. This reduction may result in slowing, or temporarily halting, the ratchet process until prices rise further. The desired effect of lowering the initial platform guarantee, and slowing the ratchet, may be to reduce the overlay by the platform (i.e., the guaranteed amount in excess of total user bids). In an example, a ratchet process may include a target overlay as an overall percentage of the money in, or max absolute dollar figure.

In another example, the market server 102 (FIG. 1) and/or the match engine 206 (FIG. 2) may factor in other parameters for adjusting the prize pool and/or share count, such as event stock, final share values, internal projections, expected user demand, projected performance per event stock, event duration, and/or live bid prices.

In another aspect, the market server 102 (FIG. 1) and/or the match engine 206 (FIG. 2) may allow users 110 (FIG. 1) to short (interchangeably referred to herein as “short sell” or “sell short”) the shares for a player. For example, the market server 102 (FIG. 1) and/or the match engine 206 (FIG. 2) may receive a request from the user 110 (FIG. 1) indicating that the user wants to short sell one or more shares of a player A that the user 110 (FIG. 1) owns. In response, the market server 102 (FIG. 1) and/or the match engine 206 (FIG. 2) may determine the short amount needed to be paid by the user 110 (FIG. 1) shorting the shares based on a difference between ranked payout amount and a current shared trade amount of the player. For example, if this is the first player that the user 110 (FIG. 1) is shorting, the market server 102 (FIG. 1) and/or the match engine 206 (FIG. 2) may calculate the short amount (e.g., $6.00) as a difference between a first place payout amount (e.g., f$10.00 on FIG. 3D) and a current share trade amount (e.g., f$4.00 on FIG. 4).

In another example, if this is the second player (or any number of shorts after shares of the first player are shorted) the user 110 (FIG. 1) is shorting, the market server 102 (FIG. 1) and/or the match engine 206 (FIG. 2) may determine the short amount based on the order that the user 110 (FIG. 1) shorts the shares for the players and the number of shares being shorted. In this example, the market server 102 (FIG. 1) and/or the match engine 206 (FIG. 2) may not allow calculations of the short amount for two players based on the same ranking (e.g., two #1—first place share payouts or two #2—second place share payouts) of a payout amount.

In the example of shares for an additional player being shorted by the user 110, the payout amounts for the number of players being shorted are determined by the market server 102 (FIG. 1) and/or the match engine 206 (FIG. 2). For example, a first place payout amount (e.g., f$25.00) per share and the second place payout amount (e.g., f$20.00) per share may be determined by the market server 102 (FIG. 1) and/or the match engine 206 (FIG. 2). In an example, the market server 102 (FIG. 1) and/or the match engine 206 (FIG. 2) may have the payout amounts (e.g., share payouts of FIG. 3D; please note this example includes different payout amounts than the example of FIG. 3D) stored in memory, and may retrieve the payout amounts from the memory based on the number of players whose shares are being shorted. The market server 102 (FIG. 1) and/or the match engine 206 (FIG. 2) may store, in memory, the retrieved payout amounts as short reserve prices, as shown by Table 5.

The market server 102 (FIG. 1) and/or the match engine 206 (FIG. 2) may also determines the order that the shares of the players (e.g., shares for player A shorted first and shares for player B shorted second) are being shorted by the user 110. For example, the market server 102 (FIG. 1) and/or the match engine 206 (FIG. 2) may store the order of shorting by the user 110 in memory, and may retrieve the order from the memory.

The market server 102 (FIG. 1) and/or the match engine 206 (FIG. 2) may also determine a number of shares being shorted for each of the players and shorting prices desired by the user 110 for shorting the shares of players, as shown by Table 5. For example, the market server 102 (FIG. 1) and/or the match engine 206 (FIG. 2) may receive, from the user terminal 104, the number of shares (e.g., 5 shares for player A, 10 shares for player B) being shorted for each of the players, and shorting prices (e.g., f$10 for player A shares, f$10 for player B shares) indicating the prices that the user 110 wants to short shares for players. In this example, the shorting prices are the same however, in other examples, the shorting prices may be different.

TABLE 5

| Shorting | | Number of Short | Shorting | Short Reserve |
|---|---|---|---|---|
| Order | Player | Shares | Price | Price |
| #1 | Player A | 5 | f$10.00 | f$20.00 |
| #2 | Player B | 10 | f$10.00 | f$25.00 |

Based on the determined shorting order, the number of short sales, the shorting price, and the short reserve price, the market server 102 (FIG. 1) and/or the match engine 206 (FIG. 2) may determine short proceeds, buy proceeds, and total proceeds for the shorting process, as shown by Table 6, where the short proceeds may, for example, equal the number of short shares multiplied by the difference between the short reserve price and the shorting price, and the buy proceeds may, for example, equal the shorting price multiplied by the number of short shares.

TABLE 6

| Shorting | | Short | | |
|---|---|---|---|---|
| Order | Player | Proceeds | Buy Proceeds | Total Proceeds |
| #1 | Player A | f$50.00 | f$50.00 | f$100.00 |
| #2 | Player B | f$150.00 | f$100.00 | f$250.00 |
| Total | | | | f$350.00 |

Further, the market server 102 (FIG. 1) and/or the match engine 206 (FIG. 2) may determine the payout price (based on players end ranking in the market) and the max payout amount, as shown by Table 7. For example, the market server 102 (FIG. 1) and/or the match engine 206 (FIG. 2) may also determine the ranking of the players being shorted when the market ends. In this example, it is assumed player A ended the market in second place (with payout amount of f$20.00) and player B ended the market in first place (with a payout amount of $25.00). In an example, the market server 102 (FIG. 1) and/or the match engine 206 (FIG. 2) may store the player ranking (e.g., FIG. 3J) in memory, and may retrieve the player ranking from the memory to determine the max payout, where the max payout may equal the payout price (based on player ranking) multiplied by the number of short shares, as shown by Table 7.

TABLE 7

| Shorting | | | |
|---|---|---|---|
| Order | Player | Payout Price | Max Payout |
| #1 | Player A | f$20.00 | f$100.00 |
| #2 | Player B | f$250.00 | f$250.00 |
| Total | | | f$350.00 |

During a shorting operation, the market server 102 (FIG. 1) and/or the match engine 206 (FIG. 2) may reserve a maximum amount from the user 110 so the market server 102 does not lose money. So in this example, based on the number of short shares, and assuming player A finishes in second place for f$20.00 per share and player B finishes in first place for f$25.00 per share, the maximum payout amount is f$350.00.

As shown by this example, the market server 102 (FIG. 1) and/or the match engine 206 (FIG. 2) may dynamically adjust the short reserve price based on the shorting order. For example, as shown by Table 5, short reserve price for the shorting order #1 and shorting order #2 based on a higher number of shares being shorted in order #2.

In contrast, without the dynamic adjustment being performed by the market server 102 (FIG. 1) and/or the match engine 206 (FIG. 2), the market server 102 may lose money. For example if the short reserve prices for player A is f$25.00 and for player B is f$20.00, the total proceeds would equal f$325.00, which means the market server 102 would lose f$25.00 (e.g., max payout amount−total proceeds).

Additionally, during the shorting process, the market server 102 (FIG. 1) and/or the match engine 206 (FIG. 2) may reserve f$125.00 for player A at the time of order #1, as the order is initially determined based on the assumption of a short reserve price of f$25.00. Therefore, order #2 may only cost an additional f$225.00 for player B at the time of order #2 (f$125.00 Player A+f$225.00 Player B=f$350.00 total).

By using the above operations to allow shorting in a market, the market server 102 (FIG. 1) and/or the match engine 206 (FIG. 2) may avoid an unlimited upside (i.e., user 110 (FIG. 1) has no bounds on gains) or an unlimited downside (i.e., user 110 (FIG. 1) has no bounds on losses) that could happen in the case of, for example, an actual stock short, and/or may avoid dealing with margins that are typically dealt with by actual stock shorts.

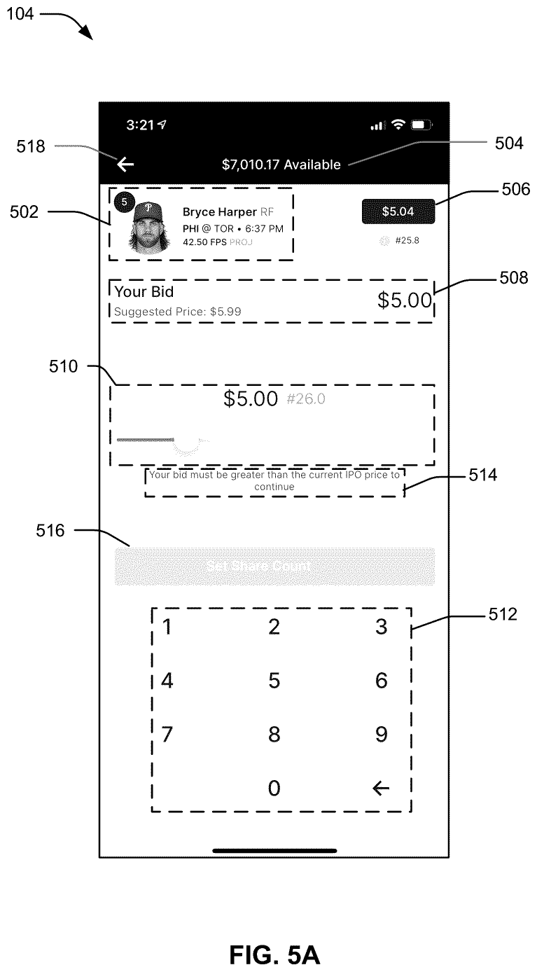

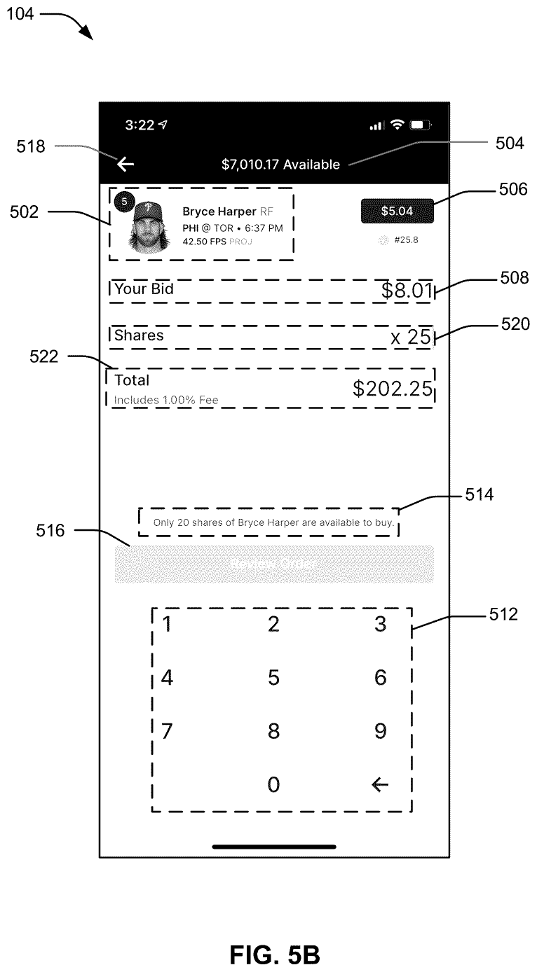

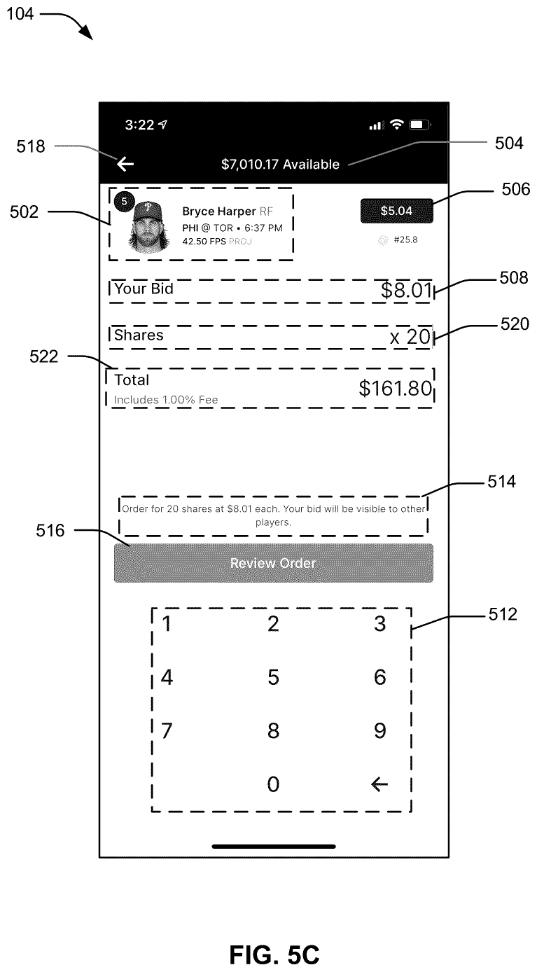

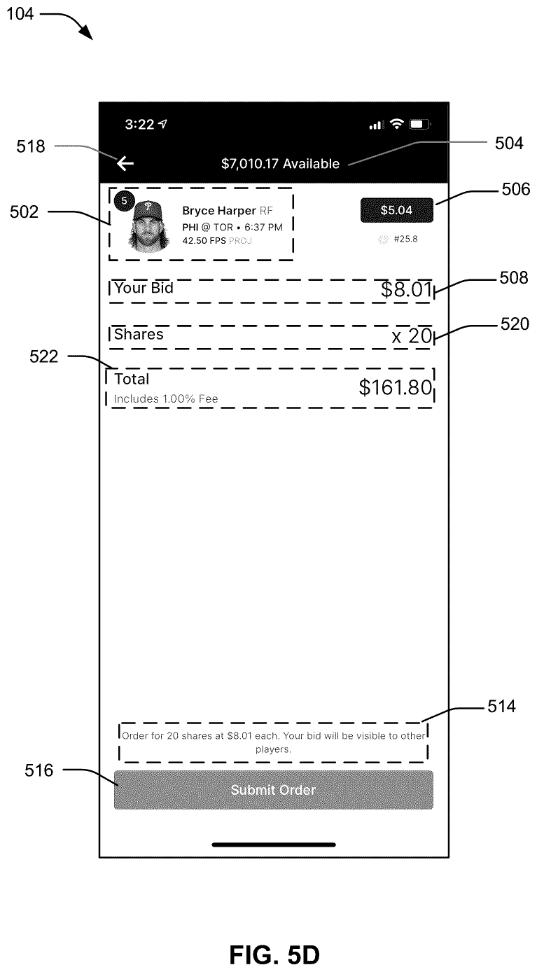

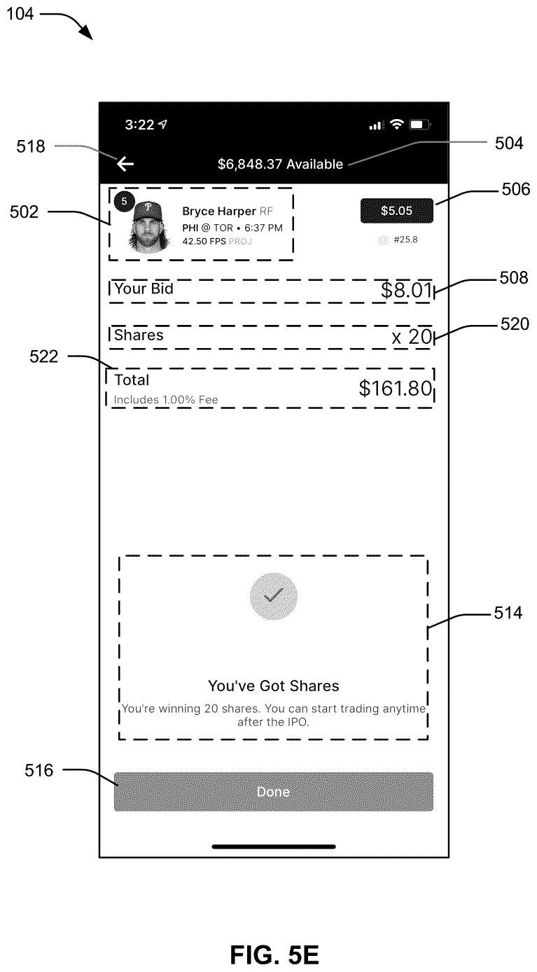

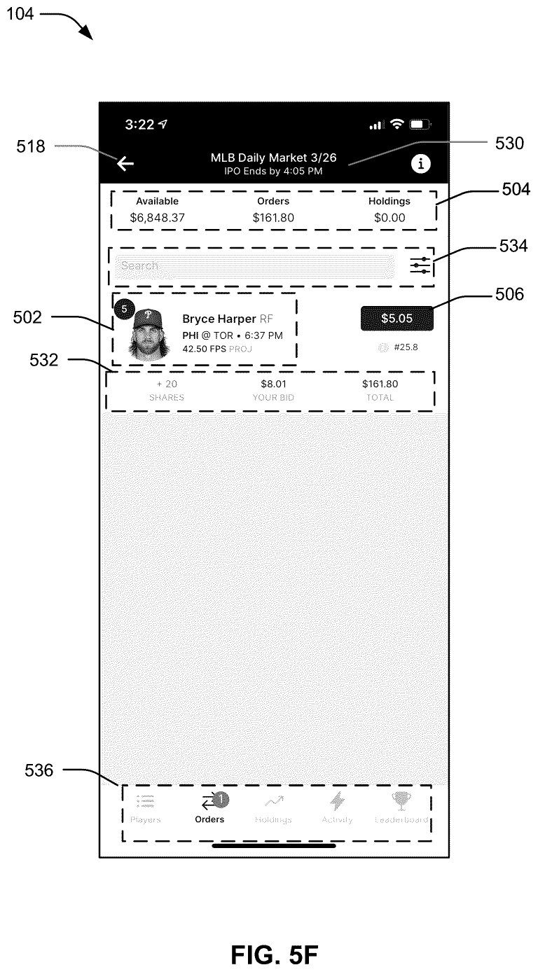

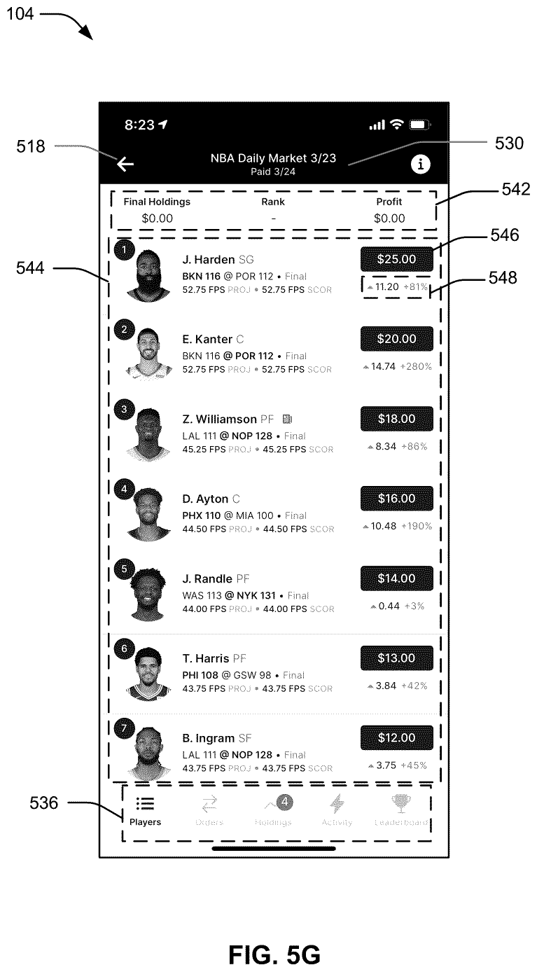

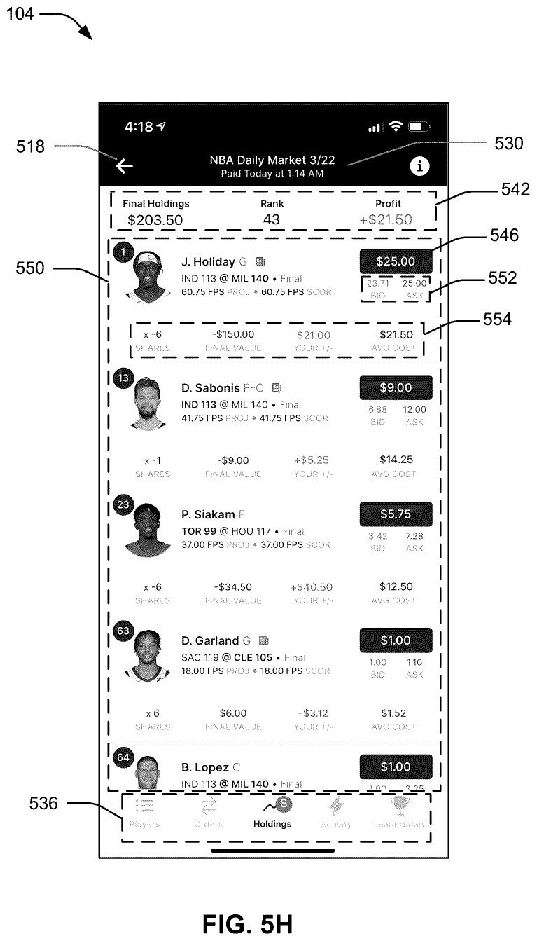

Further implementations of the system 100 are described below in reference to FIGS. 5A-5H, which illustrate additional examples of operation of the live event market through views by a single user terminal 104, which may represent any one of the user terminals 104a-104e.

Referring to FIG. 5A, a user terminal 104 (FIG. 1) may display a first screen for entering a price for an order. In an example, the user 110 (FIG. 1) may indicate at the user terminal 104 (FIG. 1) to initialize a bidding process on a player for an event. The user terminal 104 may communicate with the market server 102 (FIG. 1) the intentions of the user 110 (FIG. 1) and provide the user terminal 104 with information corresponding to the bidding of the player. In an example, the user terminal 104 may receive from the market server 102 (FIG. 1) and display player information 502 corresponding to a player that the user 110 (FIG. 1) wants to bid on shares. The player information 502 may include the player's number in the market game (e.g., 5), the player's name (e.g., Bryce Harper), the player's position (e.g., right fielder), a game the player is playing in (PHI vs Tor), a start time of game (e.g., 6:37 PM), and/or a projected fantasy points (e.g., 42.50 proj. FPS) of the player during the game.

The user terminal 104 may also receive from the market server 102 (FIG. 1) and display account information 504 indicating, for example, an amount of money (fantasy or real) available for the user 110 (FIG. 1) to make bids on players.

The user terminal 104 (FIG. 1) may also receive from the market server 102 (FIG. 1) and display a current IPO amount 506 indicating a current IPO amount (e.g., $5.04) that the shares for the player are selling for.

The user terminal 104 (FIG. 1) may display bid information 508 indicating an amount (e.g., $5.00) the user 110 (FIG. 1) is currently wanting to bid on the player, and/or a suggested amount ($5.99) for bidding on IPO shares. In an example, the user terminal 104 (FIG. 1) may receive the suggested amount from the market server 102 (FIG. 1).

The user terminal 104 (FIG. 1) may include one or more accessories such as a slide scale 510 or a keypad 512 to allow a user to enter information such as a bid amount. Further, the user terminal 104 (FIG. 1) may also receive from the market server 102 (FIG. 1) and display notifications 514 to indicate information corresponding to the current operation, for example, that the user should increase the bid amount to be greater than the current IPO price to continue.

In an example, the user terminal 104 (FIG. 1) may display a button 516 which allows the user 110 (FIG. 1) to proceed to a next step in the bidding processes. In an example, the button 516 may not be active and/or remain a first color (e.g., gray) until one or more conditions for bidding (e.g., the bid being greater than the IPO price) are met. Once the one or more conditions are met, the button 516 may be activated and/or switch to a second color to indicate the button is active for the user 110 (FIG. 1) to proceed to a next operation in the bidding process.

In an example, the user terminal 104 (FIG. 1) may display one or more additional buttons 518 (e.g., back button) to allow the user to navigate to other screens or portions of the bidding process or to return to a main menu, etc.

Referring to FIG. 5B, the user terminal 104 (FIG. 1) may display a second screen for entering an order quantity. For example, once the user 110 (FIG. 1) has indicated a bid amount for buying shares of the player and the user 110 (FIG. 1) has clicked on the button 516, the user terminal 104 (FIG. 1) may display information corresponding to the shares for the player. For example, the user terminal 104 (FIG. 1) may display a screen that allows the user 110 (FIG. 1) to indicate a number of shares the user 110 (FIG. 1) wants to purchase. In an example, the user 110 (FIG. 1) may enter the number of shares in a shares section 520 of the screen. In this example, the user terminal 104 (FIG. 1) or the market server 102 (FIG. 1) may calculate a total amount for purchasing the shares and display the total amount in a total section 522. The total amount may include any fees charged by the market server 102 (FIG. 1) for participating in the market, and this amount may be indicated in the total section 522, as illustrated by FIG. 5B.

The user terminal 104 (FIG. 1) may receive from the market server 102 (FIG. 1) and display the notifications 514 corresponding to the shares purchasing, for example, an indication on the number of shares of the player available to buy.

Referring to FIG. 5C, the user terminal 104 (FIG. 1) may display a third screen for confirming an order quantity. For example, the user 110 (FIG. 1) may enter the amount of shares (e.g., 20) the user wants to purchase using the keypad 512, and when the amount is entered and any conditions are met, the button 516 may be activated to allow the user to proceed to a next screen (e.g., review order). Further, the user terminal 104 (FIG. 1) may receive from the market server 102 (FIG. 1) and display any additional notifications 514 corresponding to the shares purchasing, for example, an indication that the share purchase information may be visible to other players.

Referring to FIG. 5D, the user terminal 104 (FIG. 1) may display a fourth screen for submitting a order. For example, the user 110 (FIG. 1) may be able to review all information corresponding to the bid operations for the players. In this example, the button 516 may be activated to allow a user to submit the bid order.

Referring to FIG. 5E, the user terminal 104 (FIG. 1) may display a fifth screen to indicate an order is confirmed. For example, the user terminal 104 (FIG. 1) may receive from the market server 102 (FIG. 1) and display an updated account information 504 indicating the change in the amount of money (fantasy or actual) available to the user 110 (FIG. 1). Further, the notification 514 may indicate that the user 110 (FIG. 1) has won shares of the player, and the button 516 may indicate the bid operations on complete or done.

Referring to FIG. 5F, the user terminal 104 (FIG. 1) may display a sixth screen for displaying open orders. For example, after the user 110 (FIG. 1) clicks on the button 516 to indicate that user 110 (FIG. 1) is done, the user terminal 104 (FIG. 1) may display a market screen to indicate information corresponding to the bids and share ownership for the user 110 (FIG. 1). In this example, the user terminal 104 (FIG. 1) may display general market information 530 indicating for example, the event corresponding to the market, an IPO end time, etc. The account information 504 may display additional information for the user 110 (FIG. 1) including, for example, an available amount of money for participating in the market, an order amount, and an amount in holding. The user terminal 104 (FIG. 1) may also provide any shares information 532 corresponding to the player, such as number of shares owned, bid amount for the shares, and a max amount of money spent for the shares.

The user terminal 104 (FIG. 1) may also display tools for navigating the market including, for example, a search or filter section 534 for navigating through the players (e.g., when the user 110 (FIG. 1) has purchased shares for a plurality of players) and navigation buttons 536 to allow the user to navigate to other screens, make additional purchase, look at leaders in the market, etc.

Referring to FIG. 5G, the user terminal 104 (FIG. 1) may display a seventh screen for displaying a players list. For example, after the IPO is closed and while events corresponding to the market are being played, the user 110 (FIG. 1) may select the players list icon from the navigation buttons 536. In an example, and in response to selecting the players list icon, the user terminal 104 (FIG. 1) may display current user information 542 which may include a final holding amount (e.g., amount the user 110 (FIG. 1) holds in shares), current ranking of the user 110 (FIG. 1) within the market, and how much profit the user 110 (FIG. 1) has won. The user terminal 104 (FIG. 1) may also display a player listing 544 including information on all players in the market, current rankings of the players, payout amount 546 based on each players current rank, changing share value amount 548 (based on player performance), etc.

Referring to FIG. 5H, the user terminal 104 (FIG. 1) may display an eighth screen for displaying holdings of the user 110 (FIG. 1). For example, after the IPO is closed and while events corresponding to the market are being played, the user 110 (FIG. 1) may select the holdings icon from the navigation buttons 536. In an example, and in response to selecting the holdings icon, the user terminal 104 (FIG. 1) may display the current user information 542. The user terminal 104 (FIG. 1) may also display a holdings list 550 including information on all players in the holdings of the user 110 (FIG. 1). The information in the holdings list 550 may include, for example, player information, current rankings of the players, payout amount 546 based on each players current rank, share selling/buying information 552 (e.g., BID may be a highest amount another user 110 is willing to buy a share owned by the user 110 and ASK may be a lowest amount another user 110 is willing to sell a share to the user 110), share holdings information 554 including number of shares in holding for the corresponding player, value of the shares, gains/losses, and average cost of the shares, etc.

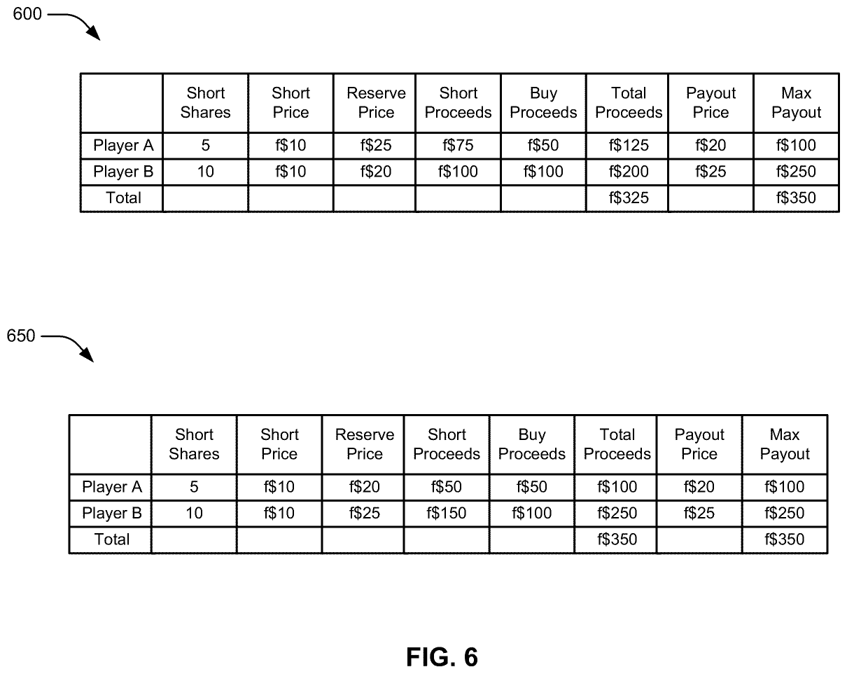

Referring to FIG. 6, an example of shorting according to aspects of the present disclosure is shown. In some implementations, two players (Player A and Player B) may be in a live event. The first place payout may be f$25 and the second place payout may be f$20. Both players (Player A and Player B) may short at $10 per share. A first order may include 5 short shares and a second order may include 10 short shares. In the examples shown below, the short proceeds may equal to the difference between the reserve price and the short price, multiplied by the short shares. The buy proceeds may be the product of the short price and the short shares. The max payouts may be the payout price multiplied by the short shares. Aspects of the present disclosure may include assigning the highest reserve price to the player having the largest number of short shares. Such assignment may prevent the platform from losing revenue during payout.

In a first example 600, the market server 102 may operate without implementing the shorting method according to aspects of the present disclosure. Specifically, the market server 102 does not assign the highest reserve price to the player having the largest number of short shares. In the first example 600, the market server 102 may assume a reserve price of f$25 per share for Player A and a reserve price of f$20 per share for Player B. The short proceeds for Player A may be f$75 ((f$25−f$10)×5 shares), the buy proceeds may be f$50 (f$10×5 shares), and the total proceeds for Player A may be f$125 (f$75+f$50). The short proceeds for Player B may be f$100 ((f$20−f$10)×10 shares), the buy proceeds may be f$100 (f$10×10 shares), and the total proceeds for Player B may be f$200 (f$100+f$100). However, since the market server 102 assumes a reserve price of f$25 for Player A and a reserve price of f$20 for Player B, the market server 102 will only have total proceeds of f$325. If Player A finishes second, its payout may be f$20 per share. If Player B finishes first, its payout may be f$25 per share. As such, the maximum payout for Player A may be f$100 (f$20×5 shares) and the maximum payout for Player B may be f$250 (f$25×10 shares). The total maximum payout may be f$350 (f$100+f$250), which is higher than total proceeds of f$325. Consequently, the platform hosting the live event may lose f$25 of revenue to cover for the difference between the total proceeds and the total maximum payout.

In a second example 650, the market server 102 may operate by implementing the shorting method according to aspects of the present disclosure. Specifically, the market server 102 may assign the higher/highest reserve price (i.e., f$25) to the player having the larger/largest number of short shares (i.e., Player B). In certain aspects of the present disclosure, in the second example 650, the market server 102 may assume a reserve price of f$20 for Player A and a reserve price of f$25 for Player B. The short proceeds for Player A may be f$50 ((f$20−f$10)×5), the buy proceeds may be f$50 (f$10×5), and the total proceeds for Player A may be f$100 (f$50+f$50). The short proceeds for Player B may be f$150 ((f$25−f$10)×10), the buy proceeds may be f$100 (f$10×10), and the total proceeds for Player B may be f$250 (f$150+f$100). Since the market server 102 assumes a reserve price of f$20 for Player A and a reserve price of f$25 for Player B, the market server 102 will have total proceeds of f$350 (f$250+f$100). If Player A finishes second, its payout may be f$20. If Player B finishes first, its payout may be f$25. As such, the maximum payout for Player A may be f$100 (f$20×5) and the maximum payout for Player B may be f$250 (f$25×10). The total maximum payout may be f$350 (f$100+f$250), which is equal to the total proceeds. Consequently, the platform hosting the live event may prevent the loss of revenue by implementing the shorting method according to aspects of the present disclosure.

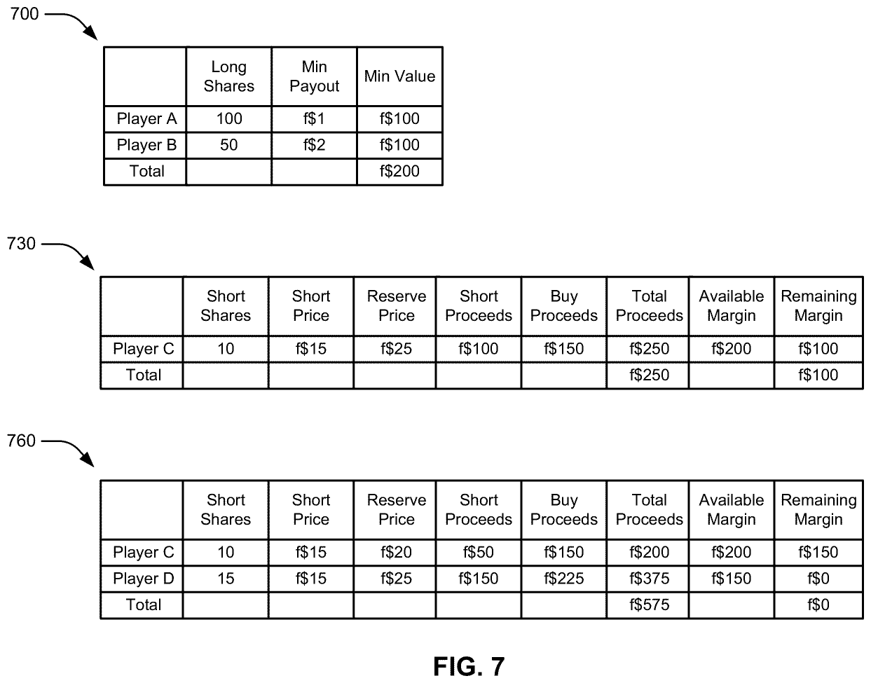

Referring to FIG. 7, an example of the margin feature according to aspects of the present disclosure is shown. The margin feature may allow users to access the future value of payout guarantees to reduce the upfront cash outlay for new share orders. In some implementations, a user may participate in a live event. Players A, B, C, and D may be in the live event. The user may have active long positions of 100 shares of Player A and 50 shares of Player B. The first place payout may be f$25, the second place payout may be f$20 . . . the second to last payout may be f$2, and the last place payout may be f$1 per share. Player C may be the first order and Player D may be the second order. Player C and Player D may be shorted at f$15 per share each. The available margin may be computed as the product of the long shares and the minimum payout.

In some aspects of the present disclosure, the market server 102 may minimize the amount of cash the user has to pay for new positions. Based on the share counts and/or the active long positions, and assuming the lowest value of margin available, the market server 102 may offer the option for the user to allocate the minimum payouts toward the short purchase. Specifically, the market server 102 may compute the available margin based on the minimum payouts by assuming the lowest possible finishing positions for shares held by the user. For example, during the live event, as shown in a table 700, the user may have active long positions of 100 shares of Player A and 50 shares of Player B. The lowest value of margin may occur when Player A finishes last (minimum payout of f$1) and Player B finishes second to last (minimum payout of f$2). Therefore, the user may have a margin of f$200 (f$1×100 shares+f$2×50 shares).

In a first example 730 according to aspects of the present disclosure, the user may initiate a short position in Player C for 10 shares at f$15 per share. Without implementing the margin feature disclosed herein, the short position may require the user to provide an additional f$100 to cover the maximum payout associated with a potential first place finish for Player C (i.e., the entire amount of the short proceeds if Player C ends up finishing first). However, accordingly to aspects of the present disclosure, the market server 102 may offer some or all of the margin (i.e., f$200) to the user to cover a portion or all of the maximum payout associated with a potential first place finish for Player C. If the user elects to allocate some or all of the margin to cover some or all of the maximum payout, the market server 102 may apply some or all of the margin toward the short proceeds. In the first example 730, the market server 102 applies f$100 toward the short proceeds of Player C. In alternative implementations, the market server 102 may automatically apply some or all of the margin toward short proceeds without receiving an input from the user.

In a second example 760 according to aspects of the present disclosure, the user may initiate a first short position in Player C for 10 shares at f$15 per share and a second short position in Player D for 10 shares at f$15 per share. Without implementing the margin feature disclosed herein, the short position may require the user to provide an additional f$150 to cover the maximum payout associated with a potential first place finish for Player D (i.e., the entire amount of the short proceeds if Player D ends up finishing first) and an additional f$50 to cover the maximum payout associated with a potential second place finish for Player C (i.e., the entire amount of the short proceeds if Player C ends up finishing second). However, the market server 102 may offer some or all of the margin (i.e., f$200) to the user to cover a portion or all of the maximum payout associated with a potential second place finish for Player C and/or a potential first place finish for Player D. In the second example 760, the market server 102 applies f$50 toward the short proceeds of Player C and f$150 toward the short proceeds of Player D. In alternative implementations, the market server 102 may automatically apply some or all of the margin toward short proceeds without receiving an input from the user.

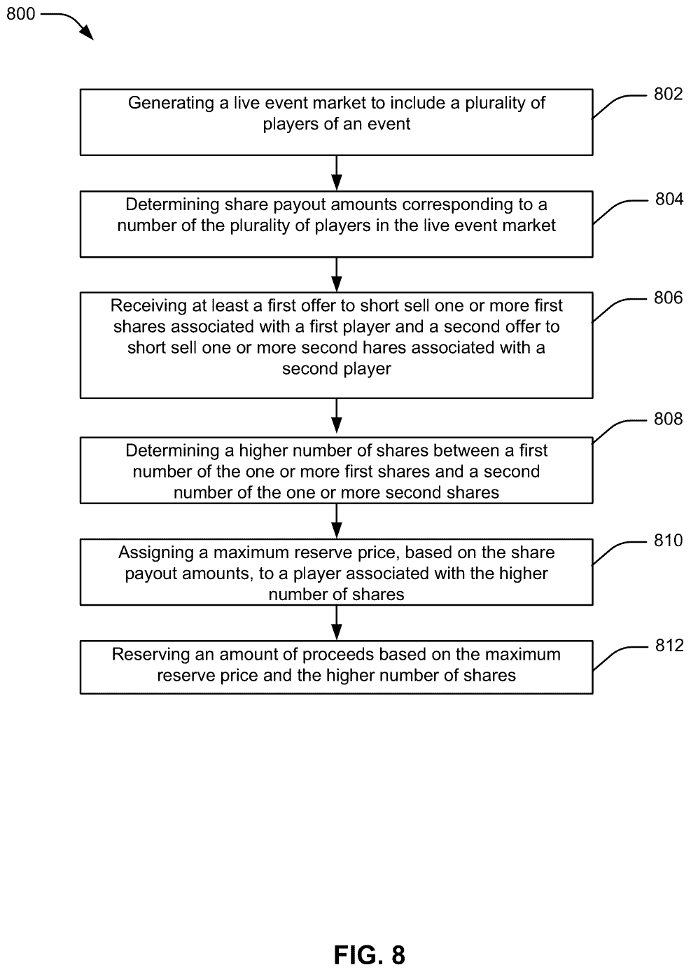

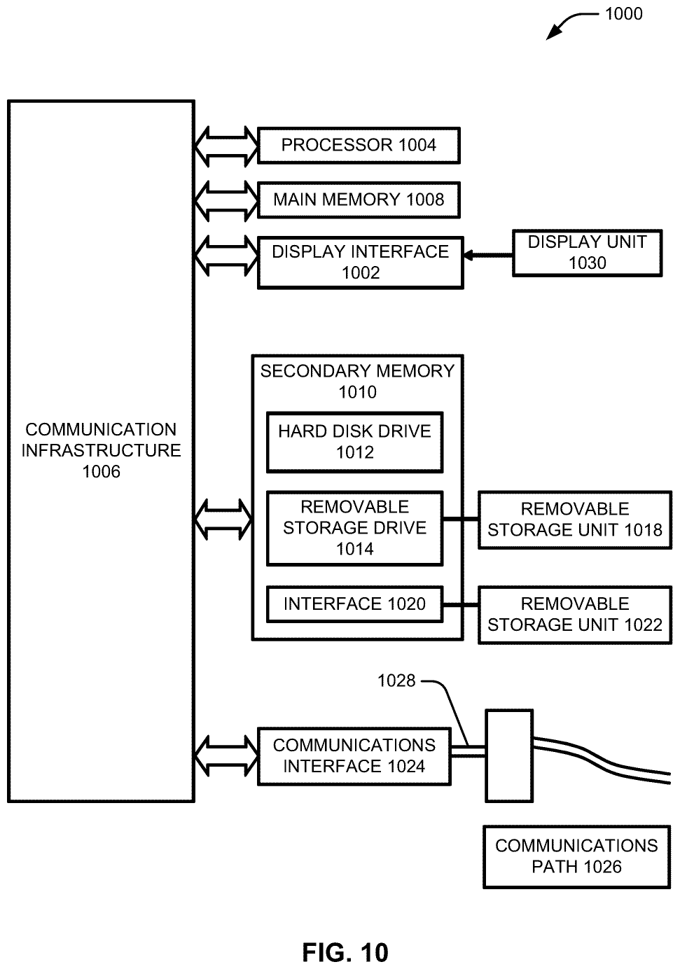

Referring to FIG. 8, a method 800 for shorting in live event markets by a computer device is depicted. In an example, the method 800 may be performed by one or more components (see e.g., market server 102 (FIG. 1) and computer system 1000, shown in FIG. 2 and FIG. 10, respectively) of the market server 102 (FIG. 1).

In FIG. 8, at block 802, the method 800 may include generating a live event market including a plurality of players of an event. For example, the market server 102 (FIG. 1) may receive input from one or more of the user terminals 104 (FIG. 1) to generate a live event market based on a selected one or more events (e.g., football games) and a plurality of users 110 (FIG. 1). In an example, the market server 102 (FIG. 1) may generate the live event market once one or more of the users pays a buy-in amount or joins the market.

At block 804, the method 800 may include determining share payout amounts corresponding to a number of the plurality of players in the live event market. For example, the market server 102 (FIG. 1) may determine the share payout amounts, such as f$25 and f$20 (FIG. 6).

At block 806, the method 800 may include receiving at least a first offer to short sell one or more first shares associated with a first player and a second offer to short sell one or more second shares associated with a second player. For example, the market server 102 (FIG. 1) may receive an offer to short sell 5 shares associated with Player A (FIG. 6) and 10 shares associated with Player B (FIG. 6).

At block 808, the method 800 may include determining a higher number of shares between a first number of the one or more first shares and a second number of the one or more second shares. For example, the market server 102 (FIG. 1) may determine that the 10 shares associated with Player B is higher than the 5 shares associated with Player A (FIG. 6).

At block 810, the method 800 may include assigning a maximum reserve price, based on the share payout amounts, to a player associated with the higher number of shares. For example, the market server 102 (FIG. 1) may assign f$25 to Player B because there are 10 shares associated with Player B (FIG. 6).

At block 812, the method 800 may include reserving an amount of proceeds based on the maximum reserve price and the higher number of shares. For example, the market server 102 (FIG. 1) may reserve f$350 based on the maximum reserve price and the higher number of shares (FIG. 6).

In an aspect, the method 800 may also include determining a plurality of scores each associated with a player of the plurality of players based on statistics of the event and determining a plurality of ranks each associated with a player in relation to other players of the plurality of players based on a corresponding score of the plurality of scores.

In another aspect, the method 800 may also include determining a final payout amount based on the share payout amounts, one or more shares purchased for the player, and a rank of the player and transmitting the final payout to a user terminal.

In another aspect, the method 800 may also include computing the amount of proceeds as a product of the higher number of shares and the highest reserve price.

In another aspect, the method 800 may also include determining a lower number of shares between a first number of the one or more first shares and a second number of the one or more second shares, assigning a second highest reserve price, based on the share payout amounts, to a player associated with the lower number of shares, and receiving the amount of proceeds based on the highest reserve price, the higher number of shares, the second highest reserve price, and the lower number of shares.

In some aspects, the method 800 may also include computing the amount of proceeds as a sum of a first product of the higher number of shares and the highest reserve price and a second product of the second highest reserve price and the lower number of shares.

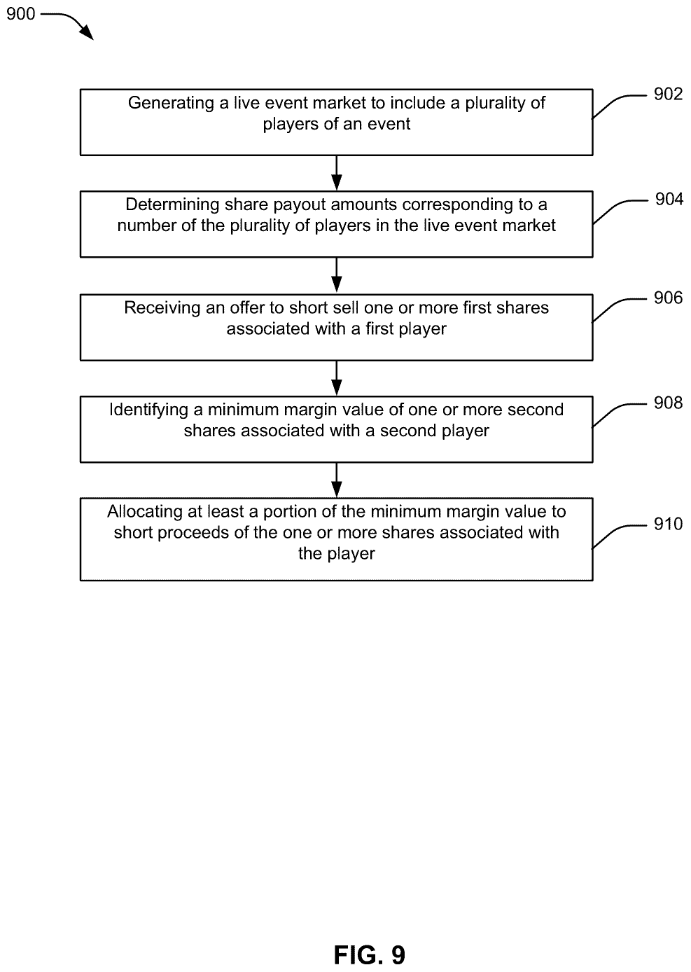

Referring to FIG. 9, a method 900 for managing margin in live event markets by a computer device is depicted. In an example, the method 900 may be performed by one or more components (see e.g., market server 102 (FIG. 1) and computer system 1000, shown in FIG. 2 and FIG. 10, respectively) of the market server 102 (FIG. 1).

In FIG. 9, at block 902, the method 900 may include generating a live event market including a plurality of players of an event. For example, the market server 102 (FIG. 1) may receive input from one or more of the user terminals 104 (FIG. 1) to generate a live event market based on a selected one or more events (e.g., football games) and a plurality of users 110 (FIG. 1). In an example, the market server 102 (FIG. 1) may generate the live event market once one or more of the users pays a buy-in amount or joins the market.

At block 904, the method 900 may include determining share payout amounts corresponding to a number of the plurality of players in the live event market. For example, the market server 102 (FIG. 1) may determine the share payout amounts, such as f$25, f$20, f$2, and f$1 (FIG. 7).

At block 906, the method 900 may include receiving an offer to short sell one or more first shares associated with a first player. For example, the market server 102 (FIG. 1) may receive an offer to short sell 10 shares associated with Player C (FIG. 7).

At block 908, the method 900 may include identifying a minimum margin value of one or more second shares associated with a second player. For example, the market server 102 (FIG. 1) may identify 100 long shares at f$1 associated with Player A and/or 50 long shares at f$2 associated with Player B. The market server 102 may identify f$200 from the long shares (FIG. 7).

At block 910, the method 900 may include allocating at least a portion of the minimum margin value to short proceeds of the one or more shares associated with the player. For example, the market server 102 (FIG. 1) may allocate f$100 toward the short proceeds of Player C (FIG. 7).

The system may continue to reevaluate other active short positions, margin requirements, and/or open orders with one or more subsequent orders, and/or other actions, that may impact a user's balance or reserve amount. The system may calculate new reserve amounts and update active positions and/or open orders accordingly as additional information becomes available.

Referring to FIG. 10, an example system for managing live event markets is depicted with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 1000 is shown in FIG. 10.

The computer system 1000 may include one or more processors, such as processor 1004. The processor 1004 is connected to a communication infrastructure 1006 (e.g., a communications bus, cross-over bar, or network). The processor 1004 may be an example of the processor 200 or a processor for the user terminal 104 (FIG. 1). Various software aspects are described in terms of this example computer system 1000. After reading this description, it will become apparent to a person skilled in the relevant art(s) how to implement aspects described herein using other computer systems and/or architectures.

The computer system 1000 may include a display interface 1002 that forwards graphics, text, and other data from the communication infrastructure 1006 (or from a frame buffer not shown) for display on a display unit 1030. The display unit 1030 may be an example of a display for the market server 102 (FIG. 1) or the display 302 of the user terminal 104 (FIG. 1). The computer system 1000 may also include a main memory 1008, e.g., random access memory (RAM), and may also include a secondary memory 1010. The secondary memory 1010 may include, e.g., a hard disk drive 1012 and/or a removable storage drive 1014, representing a floppy disk drive, a magnetic tape drive, an optical disk drive, etc. The removable storage drive 1014 may read from and/or write to a removable storage unit 1018 in a well-known manner. The removable storage unit 1018, represents a floppy disk, magnetic tape, optical disk, etc., which is read by and written to the removable storage drive 1014. As will be appreciated, the removable storage unit 1018 may include a computer usable storage medium having stored therein computer software and/or data.

In alternative aspects, the secondary memory 1010 may include other similar devices for allowing computer programs or other instructions to be loaded into the computer system 1000. Such devices may include, e.g., a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow software and data to be transferred from the removable storage unit 1022 to the computer system 1000.

The computer system 1000 may also include a communications interface 1024. The communications interface 1024 may allow software and data to be transferred between the computer system 1000 and external devices. Examples of the communications interface 1024 may include a modem, a network interface (such as an Ethernet card), a communications port, a Personal Computer Memory Card International Association (PCMCIA) slot and card, etc. Software and data transferred via communications interface 1024 are in the form of signals 1028, which may be electronic, electromagnetic, optical or other signals capable of being received by the communications interface 1024. These signals 1028 are provided to the communications interface 1024 via a communications path (e.g., channel) 1026. This path 1026 carries signals 1028 and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 1028. These computer program products provide software to the computer system 1000. Aspects described herein may be directed to such computer program products. In an example, the communications engine 208 may include the communications interface 1024.

Computer programs (also referred to as computer control logic) may be stored in the main memory 1008 and/or the secondary memory 1010. The computer programs may also be received via the communications interface 1024. Such computer programs, when executed, enable the computer system 1000 to perform various features in accordance with aspects described herein. In particular, the computer programs, when executed, enable the processor 1004 to perform such features. Accordingly, such computer programs represent controllers of the computer system 1000. The computer programs may include instructions or code for executing methods for managing live event markets, as described herein.

In variations where aspects described herein are implemented using software, the software may be stored in a computer program product and loaded into the computer system 1000 using the removable storage drive 1014, the hard disk drive 1012, or the communications interface 1020. The control logic (software), when executed by the processor 1004, causes the processor 1004 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

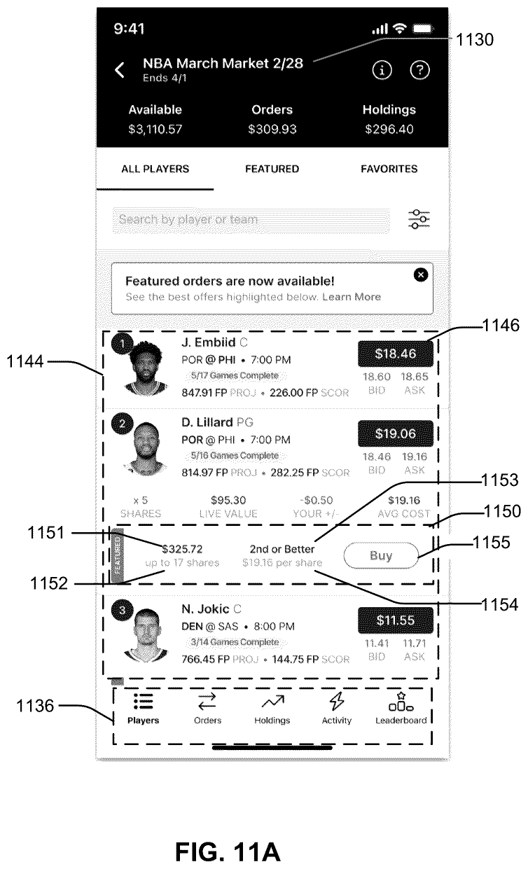

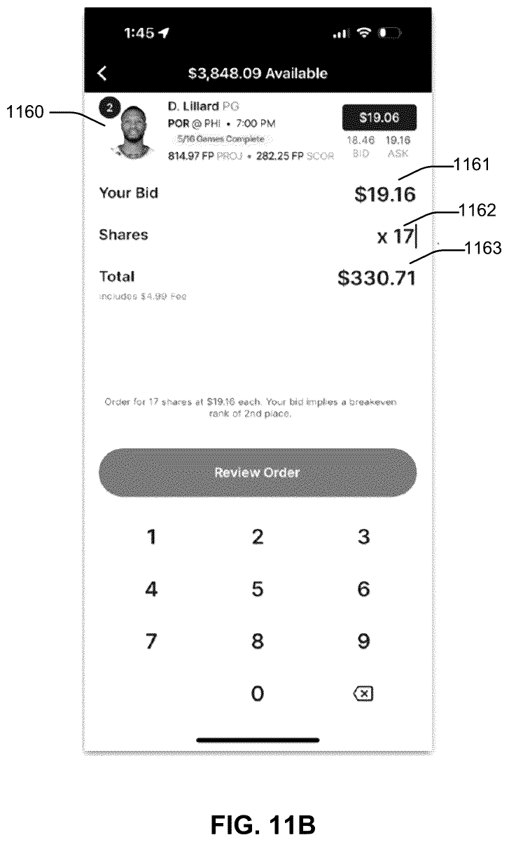

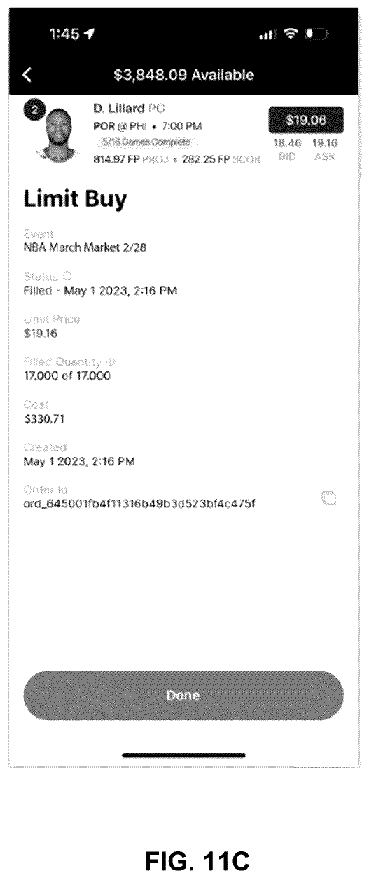

FIGS. 11A-C illustrate an example of a 1-tap featured order control according to aspects of the present disclosure. The 1-tap featured order control may promote a seamless peer-to-peer trading experience. The system may promote newly created user orders based on predetermined display criteria, e.g., 1) when an order value is more than a predetermined number (e.g., more than $100), and/or 2) when the limit price represents an available offer (e.g., best available offer). The featured order control may dynamically display one or more of “Buy,” “Sell,” or “Short” based on the direction of the open order and the viewing user's portfolio.

Referring to FIG. 11A, the user terminal 104 (FIG. 1) may display a screen for displaying a players list. For example, after the IPO is closed and while events corresponding to the market are being played, the user 110 (FIG. 1) may select the players list icon from the navigation buttons 1136. In an example, the user terminal 104 (FIG. 1) may display general market information 1130 indicating, for example, the event corresponding to the market, an IPO end time, etc. The user terminal 104 (FIG. 1) may also display a player listing 1144 including information on all players in the market, current rankings of the players, payout amount 1146 based on each player's current rank, etc. The user terminal 104 (FIG. 1) may display featured bid information 1150 associated with the second player on the player listing 1144, for example. The featured bid information 1150 may include information such as total open order amount 1151 being offered by one or more other users (i.e., limit price×quantity), equivalent number of shares 1152 available based on order amount, equivalent breakeven rank 1153 needed to justify the order price (e.g., $19.16 per share or 2^{nd} place; 1^{st}=$25, 2^{nd}=$20, and 3^{rd}=$18), actual limit price 1154 required to match the featured order, and/or a 1-tap control 1155 linked to order confirmation with pre-filled price and quantity.

Referring to FIG. 11B, in response to the user 110 (FIG. 1) tapping the 1-tap control 1155, the user terminal 104 (FIG. 1) may display a screen for confirming the pre-filled purchase order. The user terminal 104 (FIG. 1) may display the player being bid 1160, bid price per share 1161, a number of shares 1162, and the total price 1163.

Referring to FIG. 11C, in response to the user 110 (FIG. 1) confirming the pre-filled purchase order, the user terminal 104 (FIG. 1) may display a screen for reviewing order details.

Aspects of the present disclosure include a computer-implemented method of managing live event markets including generating a live event market including a plurality of players of an event, determining share payout amounts corresponding to a number of the plurality of players in the live event market, receiving at least a first offer to short sell one or more first shares associated with a first player and a second offer to short sell one or more second shares associated with a second player, determining a higher number of shares between a first number of the one or more first shares and a second number of the one or more second shares, assigning a highest reserve price, based on the share payout amounts, to a player associated with the higher number of shares, and receiving an amount of proceeds based on the highest reserve price and the higher number of shares.

Aspects of the present disclosure include the method above, further comprising determining a plurality of scores each associated with a player of the plurality of players based on statistics of the event and determining a plurality of ranks each associated with a player in relation to other players of the plurality of players based on a corresponding score of the plurality of scores.

Aspects of the present disclosure include any of the methods above, further comprising determining a final payout amount based on the share payout amounts, one or more shares purchased for the player, and a rank of the player and transmitting the final payout to a user terminal.

Aspects of the present disclosure include any of the methods above, further comprising computing the amount of proceeds as a product of the higher number of shares and the highest reserve price.

Aspects of the present disclosure include any of the methods above, further comprising determining a lower number of shares between a first number of the one or more first shares and a second number of the one or more second shares, assigning a second highest reserve price, based on the share payout amounts, to a player associated with the lower number of shares, and receiving the amount of proceeds based on the highest reserve price, the higher number of shares, the second highest reserve price, and the lower number of shares.

Aspects of the present disclosure include any of the methods above, further comprising computing the amount of proceeds as a sum of a first product of the higher number of shares and the highest reserve price and a second product of the second highest reserve price and the lower number of shares.

Aspects of the present disclosure include any of the methods above, further comprising displaying, prior to receiving the first offer and the second offer, featured bid information including a 1-tap control associated with at least one of the first offer or the second offer.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the aspects disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, including non-transitory computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

What is claimed is:

1. An apparatus for managing live event markets, comprising:
a memory storing instructions; and
one or more processors coupled with the memory and configured to:
generate a live event market including a plurality of players of an event;
determine share payout amounts corresponding to a number of the plurality of players in the live event market;
receive at least a first offer to short sell one or more first shares associated with a first player and a second offer to short sell one or more second hares associated with a second player;
determine a higher number of shares between a first number of the one or more first shares and a second number of the one or more second shares;
assign a highest reserve price, based on the share payout amounts, to a player associated with the higher number of shares; and
receive an amount of proceeds based on the highest reserve price and the higher number of shares.

2. The apparatus of claim 1, wherein the one or more processors is further configured to:
determine a plurality of scores each associated with a player of the plurality of players based on statistics of the event; and
determine a plurality of ranks each associated with a player in relation to other players of the plurality of players based on a corresponding score of the plurality of scores.

3. The apparatus of claim 2, wherein the one or more processors is further configured to:
determine a final payout amount based on the share payout amounts, one or more shares purchased for the player, and a rank of the player; and
transmit the final payout to a user terminal.

4. The apparatus of claim 1, wherein the one or more processors is further configured to:
compute the amount of proceeds as a product of the higher number of shares and the highest reserve price.

5. The apparatus of claim 1, wherein the one or more processors is further configured to:
determine a lower number of shares between a first number of the one or more first shares and a second number of the one or more second shares;
assign a second highest reserve price, based on the share payout amounts, to a player associated with the lower number of shares; and
receive the amount of proceeds based on the highest reserve price, the higher number of shares, the second highest reserve price, and the lower number of shares.

6. The apparatus of claim 5, wherein the one or more processors is further configured to:
compute the amount of proceeds as a sum of a first product of the higher number of shares and the highest reserve price and a second product of the second highest reserve price and the lower number of shares.

7. A computer-implemented method of managing live event markets, the method comprising:
generating a live event market including a plurality of players of an event;
determining share payout amounts corresponding to a number of the plurality of players in the live event market;
receiving at least a first offer to short sell one or more first shares associated with a first player and a second offer to short sell one or more second hares associated with a second player;
determining a higher number of shares between a first number of the one or more first shares and a second number of the one or more second shares;
assigning a highest reserve price, based on the share payout amounts, to a player associated with the higher number of shares; and
receiving an amount of proceeds based on the highest reserve price and the higher number of shares.

8. The computer-implemented method of claim 7, further comprising:
determining a plurality of scores each associated with a player of the plurality of players based on statistics of the event; and
determining a plurality of ranks each associated with a player in relation to other players of the plurality of players based on a corresponding score of the plurality of scores.

9. The computer-implemented method of claim 8, further comprising:
determining a final payout amount based on the share payout amounts, one or more shares purchased for the player, and a rank of the player; and
transmitting the final payout to a user terminal.

10. The computer-implemented method of claim 7, further comprising:
computing the amount of proceeds as a product of the higher number of shares and the highest reserve price.

11. The computer-implemented method of claim 7, further comprising:
determining a lower number of shares between a first number of the one or more first shares and a second number of the one or more second shares;
assigning a second highest reserve price, based on the share payout amounts, to a player associated with the lower number of shares; and
receiving the amount of proceeds based on the highest reserve price, the higher number of shares, the second highest reserve price, and the lower number of shares.

12. The computer-implemented method of claim 11, further comprising:
computing the amount of proceeds as a sum of a first product of the higher number of shares and the highest reserve price and a second product of the second highest reserve price and the lower number of shares.

13. The computer-implemented method of claim 8, further comprising:
displaying, prior to receiving the first offer and the second offer, featured bid information including a 1-tap control associated with at least one of the first offer and the second offer.

14. A computer-readable medium storing computer executable code for managing live event markets, comprising code to:
generate a live event market including a plurality of players of an event;
determine share payout amounts corresponding to a number of the plurality of players in the live event market;
receive at least a first offer to short sell one or more first shares associated with a first player and a second offer to short sell one or more second hares associated with a second player;
determine a higher number of shares between a first number of the one or more first shares and a second number of the one or more second shares;
assign a highest reserve price, based on the share payout amounts, to a player associated with the higher number of shares; and
receive an amount of proceeds based on the highest reserve price and the higher number of shares.

15. The computer-readable medium of claim 14, further comprising code to:
determine a plurality of scores each associated with a player of the plurality of players based on statistics of the event; and
determine a plurality of ranks each associated with a player in relation to other players of the plurality of players based on a corresponding score of the plurality of scores.

16. The computer-readable medium of claim 15, further comprising code to:
determine a final payout amount based on the share payout amounts, one or more shares purchased for the player, and a rank of the player; and
transmit the final payout to a user terminal.

17. The computer-readable medium of claim 14, further comprising code to:
compute the amount of proceeds as a product of the higher number of shares and the highest reserve price.

18. The computer-readable medium of claim 14, further comprising code to:
determine a lower number of shares between a first number of the one or more first shares and a second number of the one or more second shares;
assign a second highest reserve price, based on the share payout amounts, to a player associated with the lower number of shares; and
receive the amount of proceeds based on the highest reserve price, the higher number of shares, the second highest reserve price, and the lower number of shares.

19. The computer-readable medium of claim 18, further comprising code to:
compute the amount of proceeds as a sum of a first product of the higher number of shares and the highest reserve price and a second product of the second highest reserve price and the lower number of shares.

20. The computer-readable medium of claim 14, further comprising code to:
display, prior to receiving the first offer and the second offer, featured bid information including a 1-tap control associated with at least one of the first offer and the second offer.
